(19) United States
(12) Patent Application Publication
(10) Pub. No.: US 2011/0295761 A1
(43) Pub. Date: Dec. 1, 2011

(54) BUSINESS FORM MANAGEMENT SYSTEM, METHOD AND PROGRAM

(75) Inventors: Akiyoshi Sudo, Fuchu (JP); Keizo Aoyama, Hachioji (JP); Tsuneo Watanabe, Inagi (JP); Hideyuki Kobayashi, Kawagoe (JP); Keiko Ootani, Takatsu-ku (JP)

(73) Assignee: Kabushiki Kaisha Toshiba, Tokyo (JP)

(21) Appl. No.: 13/117,679

(22) Filed: May 27, 2011

(30) Foreign Application Priority Data
May 31, 2010 (JP) 2010-125054

(51) Int. Cl. G06Q 10/00

(52) U.S. Cl. 705/342

(57) ABSTRACT

According to one embodiment, a server has a first storage, a second storage, a built-in business form modification part, download execution part, and search part. The download execution part transmits the objective business form and the business form generation program stored in the first and second storage to a user terminal. The search part searches for the plant data in response to a request from the user terminal and transmits the data to the terminal. The business form generation program includes a business form definition program and a data expansion program. The business form definition program sets search conditions of plant data in the objective business form. The data expansion program requests the server to search for the plant data that satisfies the search conditions in the objective business form and outputs the plant data to the objective business form. The user terminal has an objective business form editing part and a business form generation part. The objective business form editing part edits an objective business form transmitted from the download execution part. The business form generation part executes the business form generation program to output the plant data to the edited objective business form.

This application is based upon and claims the benefit of priority from Japanese Patent Application No. 2010-125054, filed May 31, 2010; the entire contents of which are incorporated herein by reference.

### FIELD

Embodiments described herein relate generally to a business form management system, method and program which takes out a desired data from a server in which plant data has been accumulated, generates and displays a business form of the plant data.

### BACKGROUND

In various types of plants such as electric power plants, for the purpose of a steady operation, it is important to monitor and control a plant. Therefore, a computer for monitoring and control and a plant data acquisition device are provided to such a plant. These devices acquires plant data showing a state of operation of various parts of the plant regularly or each time it occurs, from sensors or measuring instruments which are attached to equipments and facilities in the various parts of the plant, or equipments or facilities themselves.

Acquired plant data are transmitted as a control data to the computer for monitoring and control to be used immediately, while they are accumulated as historical data and stored over a long period of time. This is done for the purpose of aggregating the accumulated historical data to be utilized for analysis or diagnosis.

As described above, the plant data are utilized over a wide range, it is required an environment in which many user can access to the plant data, various systems for managing plant data have been established. In general, in a system for managing plant data, a storage device, which accumulates and stores plant data acquired from a plant, is incorporated into a server, and a plurality of user terminals are connected to the server via a communication network (internet or intranet).

With such a management system of plant data, it is possible to search for plant data accumulated in the server, in response to a search request from a user terminal. Further, in a format specified by a user such as graph or business form, plant data can be taken out and search results can be displayed.

Among the formats of displaying search results of plant data, business form is effective for understanding plant data. Therefore, generation and display of business forms is indispensable for management of plant data. Therefore, as a measure to generating and displaying a business form, a plant data business form management system is incorporated in a communication network environment.

Usually, with a plant data business form management system, a user can define a business form format voluntarily, using a general table computation software program, and search for historical data in relation to data according to the defined item information, from a server in which historical data are accumulated to generate and display a business form.

In these plant data business form management system, as an operation program which allows the system to operate, a business form definition tool or data expansion tool. Among these, the business form definition tool defines a business form format, or points and period of time which are displayed in the business form format. The data expansion tool, according to the definition defined by the business form definition tool, searches for historical data which are accumulated in the server, and displays a search result of plant data on the business form format.

By the way, if operation programs as mentioned above are stored in each user terminals, when modifying the operation programs, modification is required individually for each user terminal. Revision or update of operation programs are relatively often made, the individual modification work for each user terminal, imposes a heavy load to the user.

Further, in a plant data business form management system, in general, a general purpose and commercially available table computation software program is used. Since such a table computation software program has an environment which allows a program to operate, it is considered that a program is incorporated in the business form itself to be generated to be implemented. However, if a program is incorporated in the business form itself, when perform modification of the business form definition tool or data expansion tool or version up of the program, it is necessary to perform a modification work of the program for all of the business form.

Accordingly, a network environment in which a plurality of user terminals are connected with a server, a technique is known, which holds an operation program on the server side, and makes a change in the program to be modified. With the technique, each user terminal, by downloading a modified program, can use a new program in itself. In this case, it is unnecessary to modify the program individually for each user terminal, and no program is incorporated in the business form to be generated by the table computation software program. Consequently, program modification work can be alleviated.

Note that as a technique of modifying operation programs of a plant data business form management system using a network environment in which a plurality of user terminals are connected with a server, there are a system which has a mechanism that automatically updates a program preinstalled in a user terminal, and a system which downloads a program from server for each execution.

However, in the conventional techniques have the following problems. That is, when a program of a plant data business form management system is held on a server side, program modification work can be readily, on the other hand, the business form format to be displayed is limited to fixed format or selection of several display formats. Note that as the technique in which a program of a plant data business form management system is held on a server side, for example, there is a technique in which a server side handles operations of a user terminal side and generates a business form of plant data.

When the degree of freedom in the selection of business form is low, it is difficult to generate and display a business form in any business form format that a user desires. Therefore, what has been desired is a plant data business form management system which has a simplification of the program modification work and can generate and display a business form in any business form format that a user desires.

### BRIEF DESCRIPTION OF THE DRAWINGS

FIG. 1 is a block diagram showing a first embodiment;

FIG. 2 is block diagram showing a second embodiment;

FIG. 3 is an explanatory diagram showing a business form definition part in the second embodiment;

FIG. 4 is an explanatory diagram showing a point number specification definition part in the second embodiment;

FIG. 5 is an explanatory diagram showing a point information sheet set by the business form definition part;

FIG. 6 is an explanatory diagram showing a display sheet generated from information of the point information sheet in FIG. 5;

FIG. 7 is a block diagram showing a third embodiment;

FIG. 8 is a flowchart showing a process flow of inserting a matrix in the third embodiment;

FIG. 9 is a flowchart showing a process flow of deleting a matrix in the third embodiment;

FIG. 10 is an explanatory diagram showing the contents of the point information sheet changed by adding a row in the third embodiment;

FIG. 11 is an explanatory diagram showing the contents of the point information sheet changed by adding a column in the third embodiment;

FIG. 12 is a block diagram showing a fourth embodiment;

FIG. 13 is a flowchart showing a process flow of setting copy and paste part in the fourth embodiment;

FIG. 14 is an explanatory diagram showing the contents of the point information sheet changed by copying information in the fourth embodiment;

FIG. 15 is a block diagram showing a fifth embodiment;

FIG. 16 is an explanatory diagram showing a business form definition part to which a format option specification part is added in the fifth embodiment;

FIG. 17 is an explanatory diagram showing a point information sheet set by the business form definition part of FIG. 16;

FIG. 18 is an explanatory diagram showing a display sheet generated from information the point information sheet of FIG. 17;

FIG. 19 is an explanatory diagram showing a business form definition part to which a date and time format specification part in the sixth embodiment;

FIG. 20 is an explanatory diagram showing a point information sheet set the business form definition part of FIG. 19;

FIG. 21 is an explanatory diagram showing a display sheet generated by the point information sheet of FIG. 20;

FIG. 22 is a block diagram showing a seventh embodiment;

FIG. 23 is a flowchart showing a process flow of a search direction change part in the seventh embodiment;

FIG. 24 is an explanatory diagram showing a business form definition part to which a search information change part is added in the seventh embodiment;

FIG. 25 is an explanatory diagram showing a business form definition part to which a preview display part is added in a eighth embodiment;

FIG. 26 is an explanatory diagram showing a preview screen which is displayed by execution of the preview display part in FIG. 25;

FIG. 27 is a block diagram showing a ninth embodiment;

FIG. 28 is a flowchart showing a process flow of a search direction change part in the ninth embodiment;

FIG. 29 is an explanatory diagram showing a business form definition part to which a month end processing part in a tenth embodiment;

FIG. 30 is an explanatory diagram showing a point information sheet set by the business form definition part of FIG. 29; and

FIG. 31 is an explanatory diagram showing a display sheet which is generated from information of the point information sheet of FIG. 30.

### DETAILED DESCRIPTION

With an embodiment of the invention, a plant data business form management system is provided, which is incorporated in a server and a user terminal that are adapted to be connected each other via a communication network. This plant data business form management system generates and displays a business form in response to a request form a user, based on plant data which indicates an operation state of a plant. The data business form management system has the following technical features.

The server has a first storage, a second storage, a built-in business form modification part, download execution part, and search part. The first storage is configured to store an objective business form that has a business form format displaying plant data. The second storage is configured to store a business form generation program that is provided separately from the objective business form. The built-in business form modification part modifies a business form generation program. The download execution part transmits the objective business form and the business form generation program stored in the first and second storage to the user terminal. The search part searches for the plant data in response to a request from the user terminal and transmits the obtained plant data to the user terminal.

In addition, the business form generation program includes a business form definition program and a data expansion program. The business form definition program sets search conditions of plant data in the objective business form. The data expansion program requests the server to search for the plant data that satisfies the search conditions in the objective business form and outputs the plant data to the objective business form.

In addition, the user terminal has an objective business form editing part and a business form generation part. The objective business form editing part edits an objective business form that has been transmitted by the download execution part. The business form generation part executes the business form generation program to output the plant data to the edited objective business form.

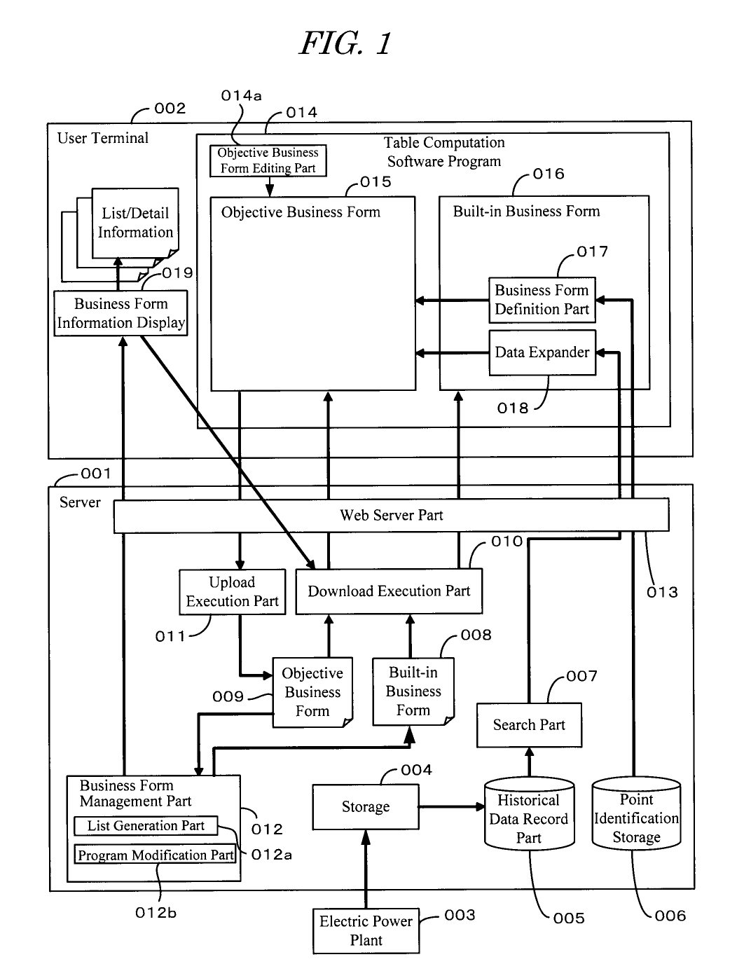

Below, one embodiment of the invention will be specifically explained referring to FIG. 1 through FIG. 30. All of the embodiments are applied to a system for generating and displaying a plant data business form of an electric power plant 003.

### First Embodiment

### {Configuration}

FIG. 1 is a block diagram showing the configuration of a first embodiment. First, the configuration of a server 001 and a user terminal 002 are explained sequentially. The server 001 and the user terminal 002 are adapted such that they can be connected with each other via a communication network such as internet or intranet.

### {Server 001}

The server 001 is provided with as data processing part, a storage 004, a historical data record part 005, a point identification information storage 006, a search part 007, a download execution part 010, an upload execution part 011, business form management part 012, and web server part 013. In addition, a built-in business form 008 and an objective business form 009 are stored in the server 001. The built-in business form 008 and the objective business form 009 are stored by individual files.

### {Objective Business Form 009}

The objective business form 009 is a sheet which defines a display style, that is, layout of plant data. As an example, the objective business form 009 is configured by cells which are distinguished by matrix, and includes information indicating a range and thickness of ruled lines, information indicating a fixed character string such as titles and a display range thereof.

### {Built-in Business Form 008}

The built-in business form 008 is a file including a business form generation program, operates on a table computation software program, and allows the objective business form to display a plant data. Specifically, the business form generation program is configured by a business form definition program and a data expansion program, and executed within the user terminal 002. By executing the business form definition program, search conditions of plant data or the like are set in the objective business form 009. The settings of search conditions or the like is a process of embedding a data of search conditions or the like in the objective business form 009. Note that the business form definition program holds in advance a data embedding position and a data to be embedded. Further, by executing the data expansion program, it is requested of the server 001 to search for plant data on the predetermined search conditions set in the objective business form 009, and allows the obtained data to be displayed in the business form 009.

### {Storage 004}

The storage 004 instantaneously acquires a plant data transmitted from a plant data acquisition device provided in the electric power plant 003, and stores the acquired plant data in the historical data record part 005, in time series. In addition, the storage 004, has not only a function of directly acquiring data from a plurality of sensors provided in the electric power plant 003, but also a function of acquiring a plant data from one or more other computers that acquires data via communication means, and a function of inputting data from various storage media.

### {Historical Data Record Part 005}

The historical data record part 005, records as historical data, a plant data of the electric power plant 003, which is acquired by storage 004. The plant data recorded in this, may include values, quality of value, and time of data, which are transmitted regularly or irregularly from the electric power plant 003. Note that the plant data transmitted irregularly from the electric power plant 003, may include a data with a recorded event of alarm occurrence and restoration, a data with a recorded operation event of automatic operation processing, and a data with a recorded operation event of a operator.

### {Point Identification Information Storage 006}

In the point identification information storage 006, point identification information is stored. The point identification information means a type of information which includes at least a point ID for identifying a plant data, point name, a unit of value, or the like. These point identification information can be edited by a commercially available and general purpose table computation software program 014 (mentioned later) but can not be saved. In other words, the point identification information of the server 001 side can not be generated by the table computation software program 014 on the user terminal 002 side.

### {Search Part 007}

Search part 007, according to the search conditions based on a request from a user, searches for a plant data recorded in the historical storage, and notifies the requesting user terminal 002. Data search methods of the search parts 007, includes a plurality of methods, such as, a method of specifying a search point, period, and cycle, a method of searching a recorded most recent value, a method of searching by a specified number in a case of irregular data, and a method of extracting only data within a period that satisfies the conditions of the plant state.

In addition, the search part 007, in addition to the above-mentioned data search function, has a function of specifying a condition that further limits the search result. Further, the search part 007 also has a function of specifying a point, date and time, and a value from the user terminal 002 to rewrite a historical data recorded in the historical record part 005.

### {Download Execution Part 010}

The download execution part 010, when received from the user terminal 002 a request of downloading any objective business form 009, copies the objective business form 009 and allows the user terminal 002 to download it.

Further, the download execution part 010, when allowing the user terminal 002 to download an objective business form 009 and a built-in business form 008, so as to allow the table computation software program 014 open the downloaded files (files 015 and 016 in the user terminal 002), transmits a start command of the table computation software program 014 to the user terminal 002.

### {Upload Execution Part 011}

The upload execution part 011, in response to a saving request from the user terminal 002, allows an objective business form 015 generated by the user terminal 002 to be uploaded to the server 001, and saves it as objective business form 009 on the server 001 side. The objective business form 015 downloaded by the user terminal 002, can be freely edited on the user terminal 002. The upload execution part 011 saves the edited objective business form 015 as objective business form 009, separately or instead of the original file.

### {Business Form Management Part 012}

The business form management part 012, manages the objective business form 009 and the built-in business form 008 stored in the server 001. The business form management part 012 has a list generation part 012a and a program modification part 012b.

The list generation part 012a, when receiving a list query of the objective business form 009 on the specified conditions from the user terminal 002, returns a list or detailed information satisfying the conditions. Note that list data managed by the business form management part 012 includes business form name of the objective management business form, file name, storage place of file, name of author, business form generation date and time, business form modification date and time, last execution date, file size, and so on.

The program modification part 012b modifies the business form generation program in the built-in business form 008. This modification process also includes saving the modified program as replacement. The modification process is performed when triggered by input operation of a user or regularly monitoring of another server. Specifically, a user performs an input of rewriting program using a keyboard or mouse, and further performs an input that indicates saving, to allow the modification process to be performed. In addition, it regularly monitors another server which holds a most recent business form generation program, when there is a more recent version of program than that held by the server 001, the most recent program is downloaded to replace the business form generation program in the built-in business form 008 with the new program.

### {Web Server Part 013}

The web server part 013, receives a request from the user terminal 002 by a protocol of HTTP or HTTPS, and notifies each processing part of each server 001 such as the business form management part 012. Further, when the web server part 013 has received an execution result of each processing part of each server 001, it returns a reply to the user terminal 002. Note that as technique of implementing the function of the web server 013, there are web server techniques such as CGI or Java Servlet, file sharing techniques using web based on WEBDAV.

### {User Terminal 002}

Next, the configuration of the user terminal 002 is explained. The user terminal 002 has as processing parts, a table computation software program 014, a business form definition part 017, a data expander 018, and a business form information display part 019.

### {Business Form Information Display Part 019}

The business form information display part 019, performs a list display of the objective business forms 009, and a transmission request of an objective business form 009 selected from the list.

In other words, the business form information display part 019, serving as a list query part, specifies search conditions of objective business form 009 included in a list, inquires a list of an objective business form 009, and serving as a display part, allows the received list to display on a display screen. The list includes detailed information of each objective business form 009, and the detailed information is also displayed on the display screen.

In addition, the business information display part 009, serving as a download request part, when received a button push event of a keyboard or mouse, transmits information that specifies the objective business form 009 displayed at a button push position in the list to the server 001 to request a download of the objective business form 009 indicated by the information. Note that the download request includes a port number that indicates the download execution part 010 on the server 001 side, to be processed by the download execution part 010.

As method of implementing the business form information display part 019, there is a method of storing a program of the business form information display part 019 on the server 001, downloading automatically the program in response to a display request of web page from the user terminal 002, and executing the program by the user terminal 002. More specifically, there are rich client techniques as web technique, such as Java Applet, Java Script, Ajax, Flash.

In addition, another method of implementing the business form information display part 019, there is ASP (Active Server Pages) technique of allowing the server 001 to execute a generation process of a screen, which is to be displayed on the user terminal 002, and transmitting only the processing result to a browser, or a technique of combining a web server technique such as JSP and rich client technique. Further, there is a technique of implementing the business form information display part 019 by a client-server type program in which a program of the business form information display part 019, has been installed in advance in the user terminal 002.

### {Table Computation Software Program 014}

The table computation software program 014, which is a commercially available and general purpose table computation software program, downloads the objective business form 009 and the built-in business form 008 of the server 001 individually, and display as the objective business form 015 and the built-in business form 016, individually on a screen. The table computation software program 014, when received a start command transmitted by the download execution part 010, is started based on the start command.

The table computation software program 014 has an objective business form editing part 014a. The objective business form editing part 014a performs in the objective business form 015, editing process such as addition or deletion of ruled lines, addition or deletion of rows and columns, copy and paste, addition, deletion or change of fixed character strings indicating titles or date and time, change of font type and size, depending on the input result of a keyboard or mouse operated by a user.

In addition, the business form generation program included in the built-in business form 016, is executed on the table computation software program 014 and allows the user terminal 002 to function as a business form generation part. When the business form definition program is executed, the business form definition part 017 functions, and when the data expansion program is executed, the data expander 018 functions.

### {Business Definition Part 017}

The business definition part 017 is a program which defines specific information of plant data and an additional position of the specific information, which are displayed by the objective business form 015. That is, the business definition part 017 is configured to store the specific information of plant data and an additional position of the specific information, which are displayed by the objective business form 015.

The specific information is, in other words, search conditions. The specific information of plant data is configured by information that indicates occurrence point of the plant data and period. Specifically, the specific information includes point ID that indicates a occurrence point of plant data, search date and time, search cycle, and so on. The search date and time indicates specifically indicates “data of X month X day”, the search cycle specifically indicates “data for each X time”. The additional position information indicates a position to which the specific information of plant data is added. The additional position information is a type of information that specifies a start cell and end cell in the objective business form 015.

The business form definition part 017 adds to a position in the objective business form 015, which is specified by the position information, the specific information that is paired with the position information. The additional process, which is embedding the specific information in the objective business form 015, describes the specific information in the objective business form 015.

In addition, the business form definition part 017 searches desired point identification information from the point identification information storage 006 stored in the server 001, and write the search result in the objective business form 015. Here, the point identification information stored in the point identification information storage 006, can not be stored by editing function of the table computation software program 014.

### {Data Expander 018}

The data expander 018 expands plant data in the objective business form 015. Specifically, it embeds plant data in the objective business form 015, in other words, describes plant data in the objective business form 015. The data expander 018 acquires the additional plant data by query retrieve to the server 001. Specifically, the data expander 018 transmits as search conditions the specific information of the plant data, which is added to the objective business form 015 by the business form identification part 017, to the search part 007 of the server 001. Then, the data expander 018 adds the plant data received from the search part 007 to the objective business form 015 according to the additional position information.

In addition, the data expander 018, when a process value displayed in the objective business form 015 is changed by a user and requested to save the changed data, rewrite the plant data. Note that the business form definition program and the data expansion program, may be defined in the same built-in business form 009, or in different business forms, respectively.

### {Action and Effect}

Next, action and effect of the first embodiment is explained. The user terminal 002 requires modification and version up of programs in various cases, in relation to program for generating an objective business format 015 as business form format, that is, a business form definition program or data expansion program in the built-in business form 016.

For example, there is a program which specifies an option to be selected in the objective business form 015, when some options are required to be added, it is necessary to modify the program itself. With the first embodiment, modification of the business form definition program and the data expansion program is performed as the following manner, action and effect of simplification of program modification work, can be achieved.

First, the built-in business form 008 stored in the server 001 is modified. Then, the download execution part 010 of the server 001 allows the built-in business form 008 to be downloaded by each user terminal 002, as a result, the defined and modified business form definition program and data expansion program can be utilized by the table computation software program 014 of the user terminal 002.

In other words, when the built-in business form 008 stored in the server 001 is modified, each user terminal 002 can generate a business form using a new program. Consequently, it is unnecessary to modify the business form generation program by individual user terminal 002, the program modification work can be performed very readily.

Moreover, in this embodiment, in addition to simplification in the program modification work, the objective business form 015 can be edited freely to a layout that a user desires on the user terminal 002 side. Therefore, the plant data business form management system according to this embodiment, simplification in the program modification work can be achieved, and a freedom in the selection of the business form format is not damaged.

Further, the plant data business form management system, can store the layout-changed objective business form 015 in the server 001. Therefore, when once a user generates an objective business form 015 of a desired layout, he can use the objective business form 015 of the desired layout if necessary. Consequently, user can be free from the disturbance in which the objective business form should be changed go a desired display style, and the degree of freedom in the business form format can be enhanced effectively.

Further, the combination of the business form management part 012 of the server 001 and the business form information display part 019, allows the edited objective business form 015 to be uploaded more effectively. In other words, the business form information display part 019, receives information regarding the objective business form 009 stored in the server 001 from the business form management part 012, and displays a list or detailed information of the objective business form 009 on a display screen. So, a user can specify any objective business form 009 that he desires based on the displayed information.

In addition, in this embodiment, since the business form definition part 017 and the data expander 018, operate in an execution environment on the table computation software program 014, these operations can be made if only the version of the table computation software program 014 is the same, without depending on another operation environment except the table computation software program, that is, such as version of operating system (OS). Therefore, the requirements for the operation environment are not severe and the usability is good.

Further, the communication between the user terminal 002 and the server 001 is implemented by the web server part 013 as communication through web. Therefore, it is unnecessary to provide a new dedicated communication port. Consequently, it can be prevented that an added port suffers an attack such as hacking, the electric power plant 003 with a high degree of publicness, can have an excellent security.

### Second Embodiment

### {Configuration}

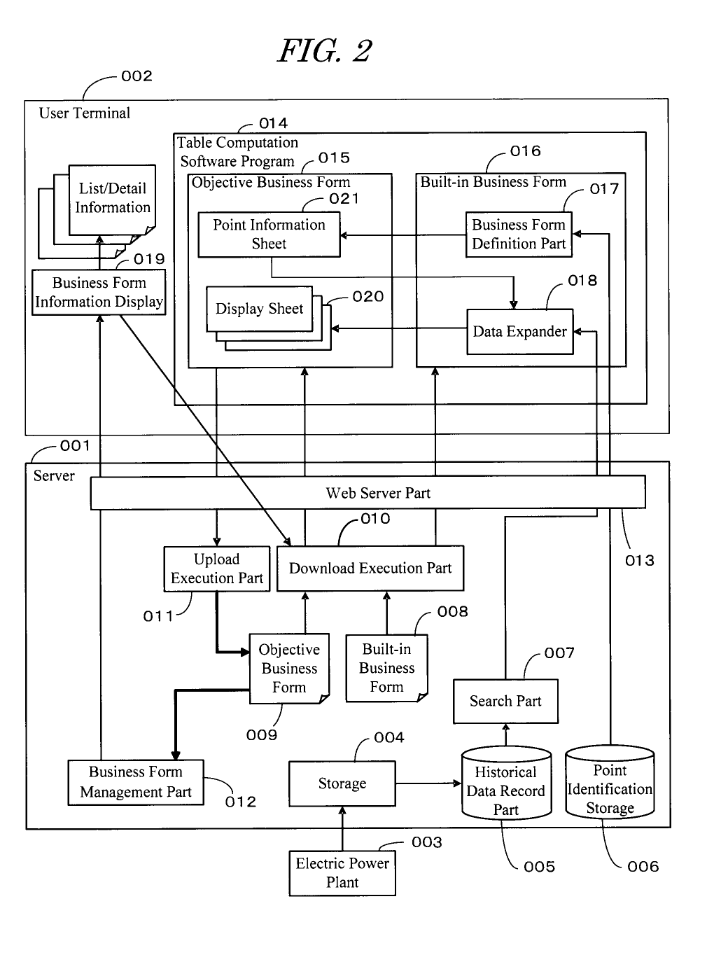

Next, a second embodiment is explained referring to the block diagram of FIG. 2. The second embodiment has a technical feature that in the table computation software program 014, the objective business form 015 is configured by one or more display sheet 020 and a point information sheet 021. The other configuration is the same as that of the first embodiment.

The display sheet 020 is a sheet, which are displayed on a screen and printed out by a user, and adapted such that search conditions of plant data are embedded in the sheet. In addition, the point information sheet 021 is a sheet for storing therein the search conditions of plant data embedded in the display sheet 020. In more detail, the search conditions in which point number, search start date and time, search period, and cycle are selected, are written in a cell of the point information sheet 021 by the business form definition part 017.

Here, the data expander 018, on the basis of the search conditions written in the point information sheet 021, allows the search part 007 to search the historical data 005, and embeds and displays the search result in each cell of the display sheet 020.

### {Display Example of Search Condition Specification Screen}

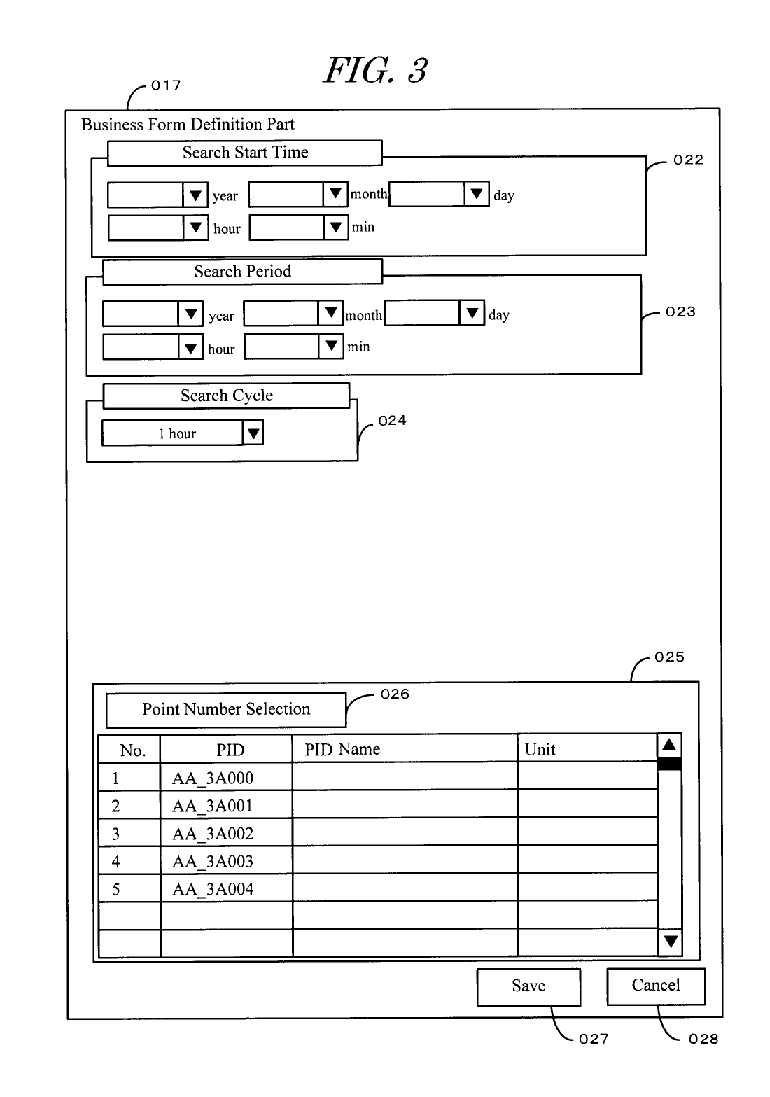

FIG. 3 shows a display example of a search condition specification screen displayed by the business form definition part 017. Note that the selection and execution of each area or button displayed on a screen, are operated by a pointing device such as mouse.

The search condition specification screen displayed by the business form definition part 017, which operates on the table computation software program 014, displays thereon, a search start date and time specification area 022, a search period specification area 023, a search cycle specification area 024, a point number specification area 025, a point number specification part 026, a saving button 027, and a cancel button 028.

The search start date and time specification area 022 and the search period specification area 023, respectively, displays a pull-down menu of year, month, date, hour and minute, and specifies by the search start date and time and the search period. The search period selected here, is to select a length of period which has passed from the date and time selected by the search start date and time. In addition, the search cycle specification area 024, specifies a selectable cycle with a pull-down menu. The selectable cycle is, for example, 30 seconds, 1 minute, 5 minutes, 10 minutes, 30 minutes, 1 hour, six hours, one day, one month, one year, and so on.

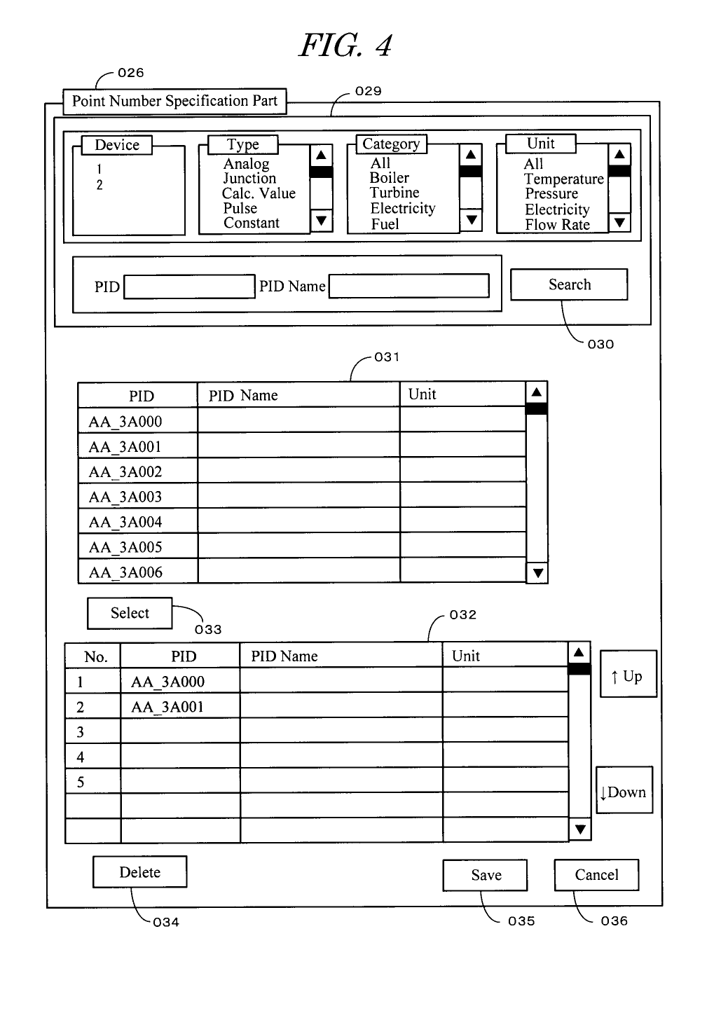

The point number specification part 026, selects, the point number specification part 026 within the point number specification area 025, and performs a selection on the point number specification screen of FIG. 4 displayed after that. When saving the specified search conditions and ending the process, the saving button 027 is selected to save the search conditions in the point information sheet 021, after that, the search condition specification screen is closed. In addition, when the cancel button 028 is selected, the search condition specification screen ends without saving the search conditions.

FIG. 4 is an explanatory diagram showing the point number specification screen displayed by the point number specification part 026. As shown in FIG. 4, the point number specification part 026 is configured by a point number search condition specification area 029, a search result display area 031, a point number selection area 032, a selection button 033, a point number deletion part 034, a saving button 035, and a cancel button 036.

First, the point number search condition specification area 029, selects the search conditions of point number to be set. As methods of setting the conditions, includes two type of methods, that is, one method of selecting a unit, type, class, quantity unit from a list box, another method of manually inputting a point number or point name in a text box.

After setting by either method, the search execution button 030 is selected to display search results on the search result display area 031. Among the search results, a point number to be set, is selected by mouse or the like, and the selection button is pushed to display a selected point number in the point number selection area 032.

This process is repeated and the selection ends, after that, when the saving button is selected, the point number selected in the point number selection area 032 is saved, the point number specification part 026 ends the process to return to the business form definition part 017. In addition, when deleting the point number set in the point number selection area 032, the point number to be deleted is selected, after that, the deletion button 034 is pushed to delete the selected point number. Further, when the cancel button 036 is selected, the search specification screen to ends without saving the search conditions.

### {Display Example of Point Information Sheet 021}

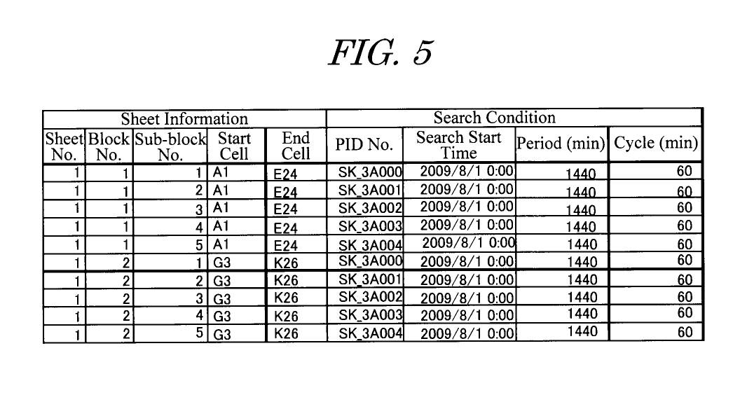

Next, FIG. 5 shows an example of the point information sheet 021. The information embedded in the point information sheet 021, includes sheet number, block number, sub-block number, start cell, end cell, point number (PID number in FIG. 5), search start date and time, search period, and search cycle.

Among the numbers, the sheet number denotes that which sheet is a sheet in which the search information of the column is set. In addition, the block number is used to identify the information specified by the business form definition part 017. Further, the sub-block number is a value that is allocated to identify the point number specified once by the business form definition part 017.

In the table computation software program 014, the number of the most left sheet is defined as “1”, and the sheet number incremented one by one in the right direction of the sheets. On the display sheet 020, all of the search conditions specified by the business form definition part 017, are allocated with the same block number. In addition, on the same display sheet 020, when a business form format is set by the business form definition part 017 with divided into a plurality of times, in the setting order set by the business form definition part 017, the block number is allocated from 1 in ascending order. Further, the sub-block number is allocated from 1 in ascending order.

The start cell is used when the business form definition part 017 is invoked, a cell position selected in the display sheet 020 is embedded, and the specified search conditions are embedded in the display sheet 020. The end cell is a cell position which is the last value is embedded when the search conditions set by the business form definition part 017 are embedded in the display sheet, and computed from the information including the number of the specified point number, search start date and time, search period, search cycle, and start cell.

The point information sheet 021 holds the search conditions for the display sheet 020, is configured to store the search conditions specified by twice execution of the business form definition part 017. The search condition specified by the business form definition part 017 at the first time, is a row having the block number “1”, and the search condition specified by the business form definition part 017 at the second time, is a row having the block number “2”.

When the cell position selected by the display sheet 020 when invoking the business form definition part 017 at the first time, is “A1”, and the start point is “A1” when expanding the business format. Regarding the point number (PID number in FIG. 5), five points, SK_3A000, SK_3A001, SK_3A002, SK_3A003, SK_3A004 are specified as the search points.

When searching the historical data of the five point numbers, it is the condition that the search is performed starting from the historical data of “the 1st day of August, 2009, time: 00:00” at a cycle of one hour, for each one day (24 hours). The end cell position is “E24” when expanding the business form format, here, the historical data of “the 1st day of August, 2009, time: 23:00” of the point number SK_3A004, is embedded in “E24”. The search conditions by the business form definition part 017 at the second time, is expanded as the start point from the point G3, the end cell position is K26.

### {Display Example of Display Sheet 020}

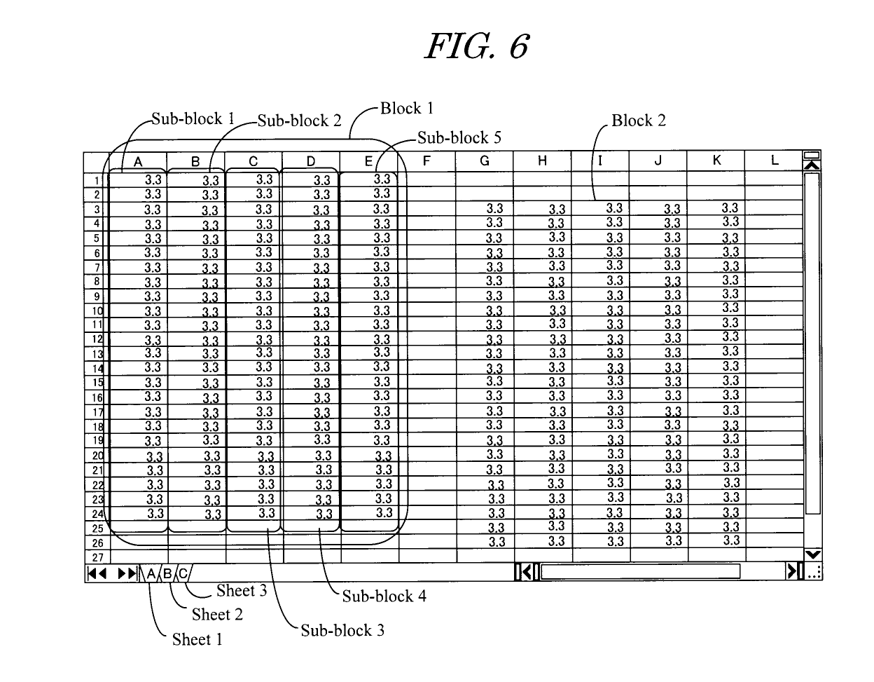

FIG. 6 is a display example of a business form format expanded in the display sheet 020, on the basis of the information in the point information sheet of FIG. 5. In the display sheet 020 shown in FIG. 6, the block “1”, “2” in the sheet number “1”, and sub-blocks “1” through “5” are displayed.

### {Action and Effect}

With the second embodiment, in addition to the action and effect of the first embodiment, action and effect of improvement in the display process speed of the historical data. This point is explained. That is, so as to search the historical data in the business form format generated within the objective business form 015, it is necessary to store the search conditions such as point information or search period in the storage. Then, when searching, the stored search conditions are invoked from the storage, the historical data is searched on the basis of the search conditions.

When the external file outside the business form is selected as the storage destination of the search conditions, if only the objective business form 015 is opened using the table computation software program 014, it is not clear that which historical data of which point number and which date and time is to be searched. Therefore, it is necessary to make a check test of the setting contents, to allow the search efficiency to be deteriorated.

Thus, in the second embodiment, the display sheet 020 and the point information sheet 021 are separately provided within the objective business form 015, and the search conditions are embedded in the point information sheet 021. Therefore, the search of the historical data can be made securely on the basis of the search conditions stored in the point information sheet 021. Consequently, the search result can be embedded for each point number, into the display sheet 020, to enhance in the display process speed of the historical data.

### Third Embodiment

### {Configuration}

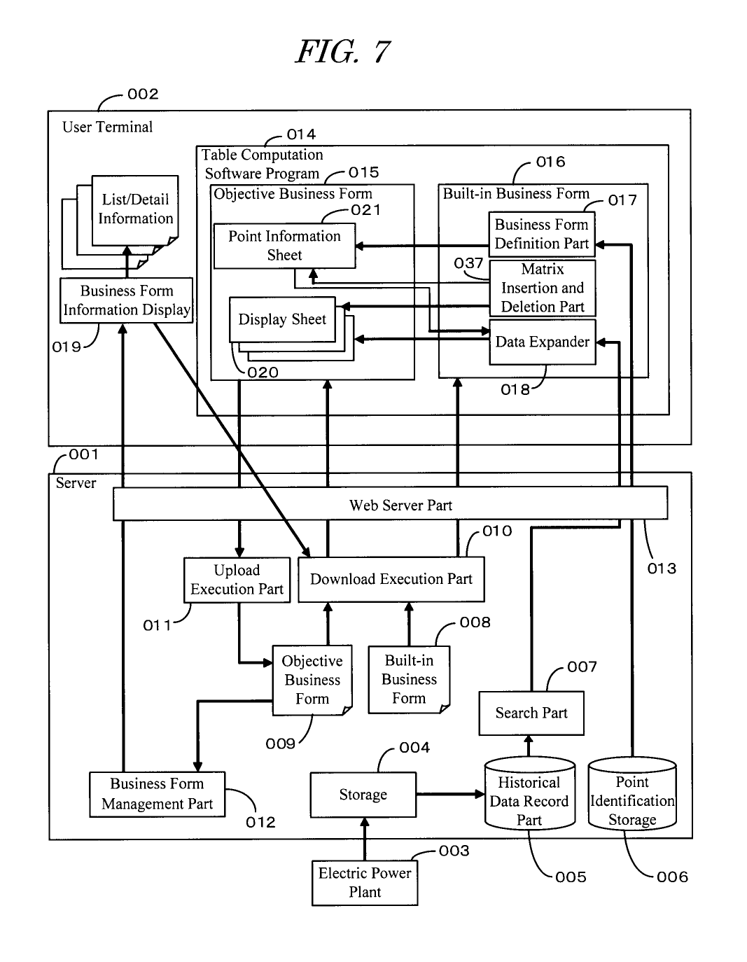

FIG. 7 shows a block diagram of a third embodiment. As shown in FIG. 7, the third embodiment has a technical feature that the business form generation program includes a matrix insertion and deletion program, and serves as a matrix insertion and deletion part 037 on the user terminal 002.

The matrix insertion and deletion part 037 is a consistency adjustment part that is configured so as to insert and delete a row or column between a plurality of points or a plurality of date and times that form a period of time. Note that the other configuration is the same as the second embodiment.

### {Process Flow}

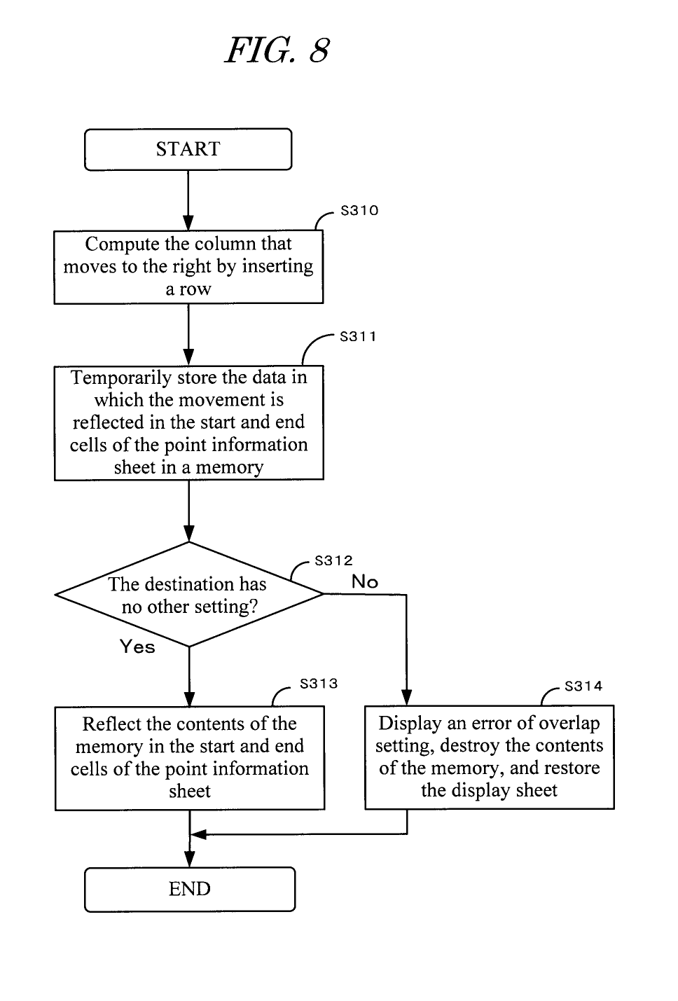

The flowchart of FIG. 8 shows a process flow of inserting a matrix. As shown in FIG. 8, The matrix insertion and deletion part 037 inserts a row or column in the specified position in the display sheet 020 of the objective business form 015, the column that moves to the right by inserting the row is computed (S310). Subsequently, as a computed result, a data in which the movement is reflected in the start cell and end cell of the point information sheet 021, is temporarily stored in a specific memory (S311).

In other words, a new row is added to the point information sheet 021 of the objective business form 015, to adopt a new block number and a new sub-block number, and then, write in a specific column, those block numbers together with the sheet number or the start cell of the inserted sheet. Then, at step S312, it is checked whether the movement destination has another setting, and when there is no other setting (Yes in S312), the contents stored in the memory is reflected in the start cell and end cell of the point information sheet (S313).

On the other hand, when the movement destination has another setting (No in S312), an error display of overlap setting is performed, and the contents stored in the memory is destroyed to restore the display sheet 020 to the original state (S314). Note that regarding existing information, which has moved by inserting a matrix in the display sheet 020, the start cell and end cell of the point information sheet 021, can be set again in the movement destination.

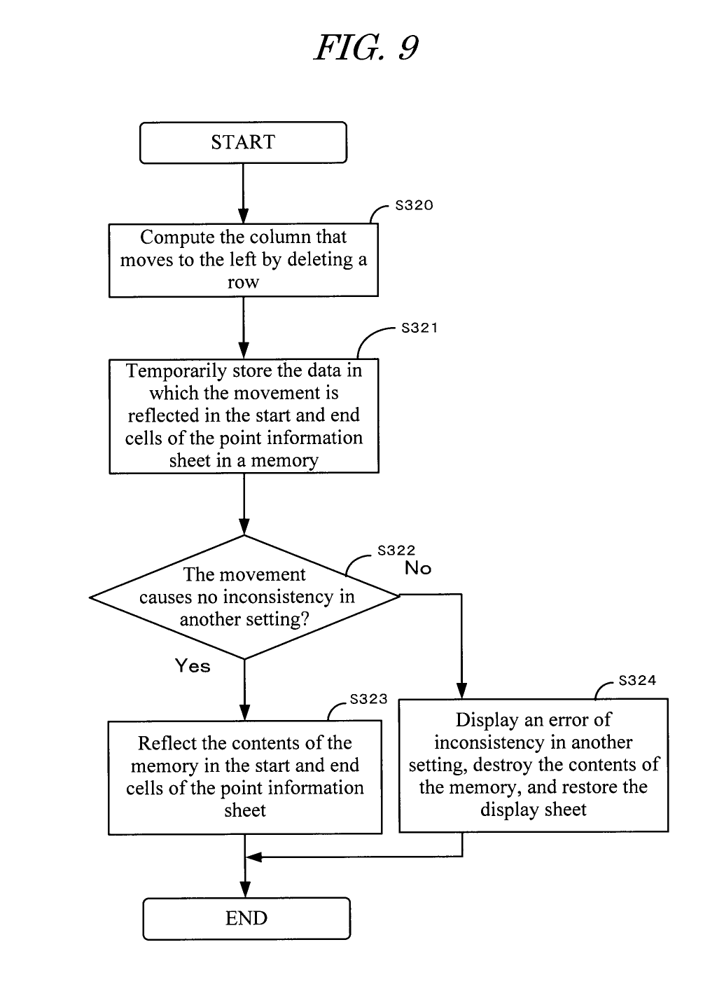

In addition, as shown in the flowchart of FIG. 9, the matrix insertion and deletion part 037 deletes a row or column at a specified position in the display sheet 020 of the objective business form 015, the column that moves by deleting the row is computed (S320). Subsequently, as the computed result which the movement is reflected in the start cell and end cell of the point information sheet 021, is temporarily stored in a specific memory (S321).

Subsequently, it is checked whether the movement causes an inconsistency in another setting (S322), when there is no conflict (Yes in S322), the contents stored in the memory is reflected in the start cell and end cell of the point information sheet (S323). On the other hand, there is an inconsistency (No in S322), an error of inconsistency in the other setting is displayed, and the contents stored in the memory are destroyed to restore the display sheet 020 to the original state (S324). Note that regarding existing information, which has moved by deleting a matrix in the display sheet 020, the start cell and end cell of the point information sheet 021, can be set again in the movement destination.

### {Action and Effect}

With the third embodiment, in addition to the action and effect of the first embodiment, a unique action and effect can be obtained, such as the generated business form can be readily changed. In other words, so as to hold consistency with the editing result of the objective business form 015, the consistency adjustment part automatically changes the additional position of plant data. Therefore, it is unnecessary for a user to change the point information sheet 021 or the business form definition program depending on the editing of the objective business form 015, the editing of the objective business form 015 can be made more readily. This point is explained. In the objective business form 015, when the point information sheet 021 and the display sheet 020 are provided separately, even if the display sheet 020 is edited by inserting or deleting a row or column which are prepared by the table computation software program 014, with regard to the information of the start cell and end cell set in advance in the point information sheet 021, the information can be maintained as it is without update.

In other words, there is some possibility of a trouble in which although the display position of the display sheet 020 is changed, data is displayed in the original display position set in the point information sheet 021. For example, when generating a business form, which displays from 1:00 to 24:00 and inserts a blank row at each 6 hours, it is necessary to set the search conditions in the divided periods of 1:00 to 6:00, 7:00 to 12:00, 13:00 to 18:00, and 19:00 to 24:00, as a result, a long time is required for generating a business form.

Thus, the matrix insertion and deletion part 037 is defined in the built-in business form 016, and the matrix insertion and deletion part 037 operates on the table computation software program 014, insertion and deletion of rows and columns can be executed readily. Therefore, when generating an aggregated business form for one day, in which a plurality of aggregated values or mean values are aggregated, the modification can be made readily.

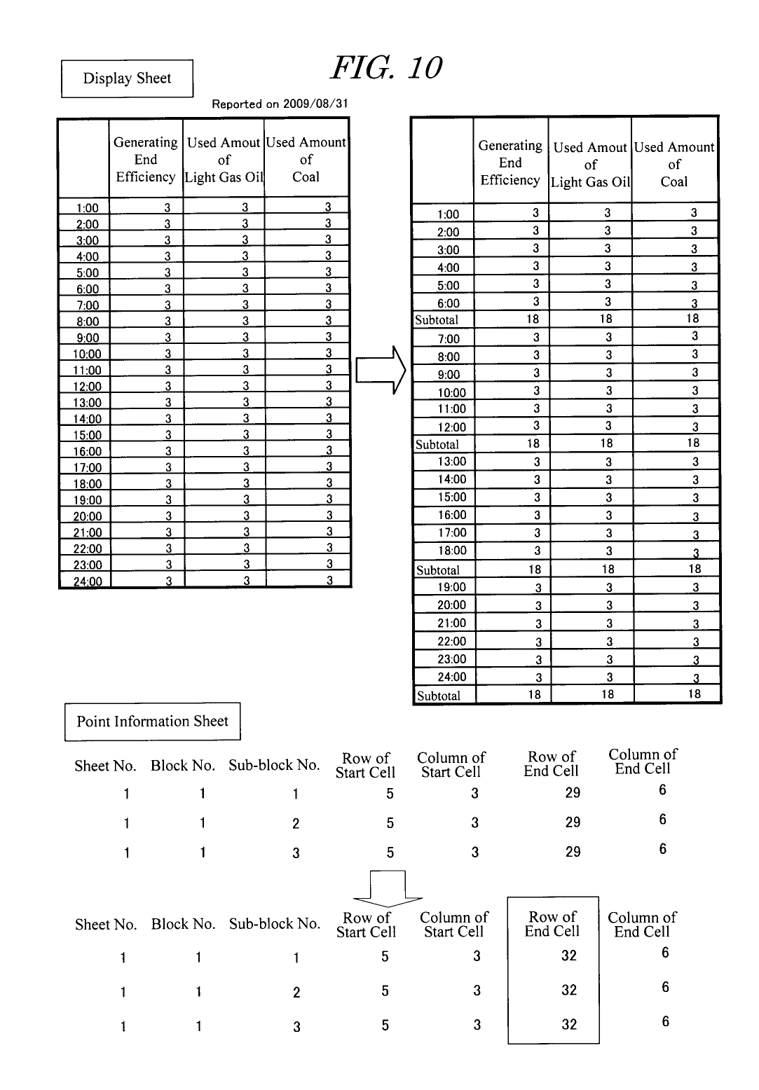

More specifically, for example, as shown in FIG. 10, after generating a daily report, even if a display field is added for displaying the aggregated of each item for each 6 hours, by service of the matrix insertion and deletion part 037, a row can be readily inserted in a predetermined area in the daily report.

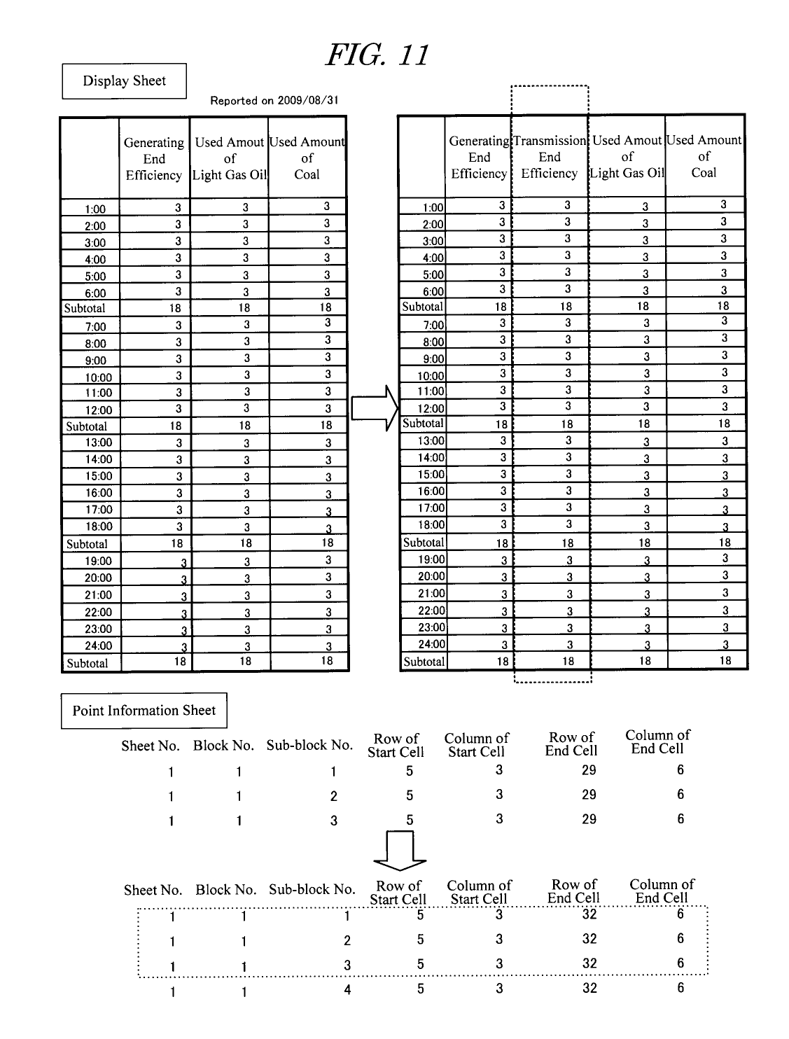

In addition, as shown in FIG. 11, after generating a daily report, for example, even if a display field is added for displaying the efficiency at the end of a power transmission line, by service of the matrix insertion and deletion part 037, a row can be readily inserted in a predetermined area in the daily report. Note that inserting and deleting a matrix is effective when generating not only a daily report but also a monthly report. In other words, by inserting a row a monthly report after it was generated, rows can be added for displaying aggregated values of the first third, second third, and last third of the month, or of each half-month, after it was generated.

### Fourth Embodiment

### {Configuration}

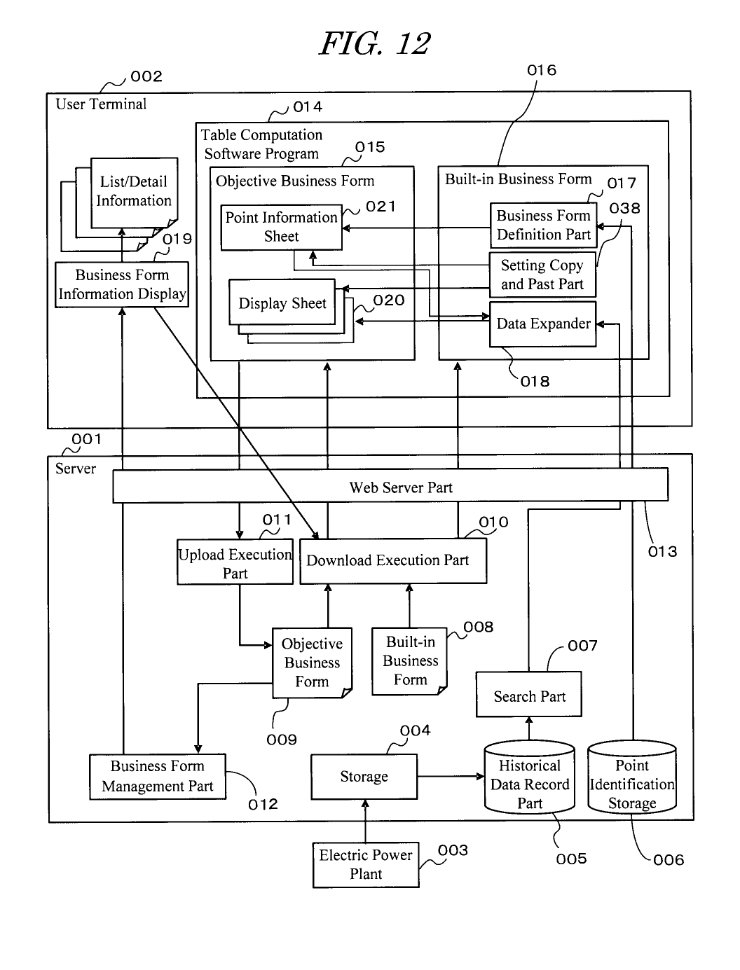

Next, referring to the block diagram of FIG. 12, a fourth embodiment is explained. The fourth embodiment has a technical feature in which a setting copy and paste program is included in the business form generation program, and functions as a setting copy and paste part 038 on the user terminal 002.

The setting copy and paste part 038 is a consistency adjustment part which copies or cuts the setting information of a plurality of points and periods collectively, and pastes the copied or cut setting information in any different area. Note that the other configuration is the same as the second embodiment.

### {Process Flow}

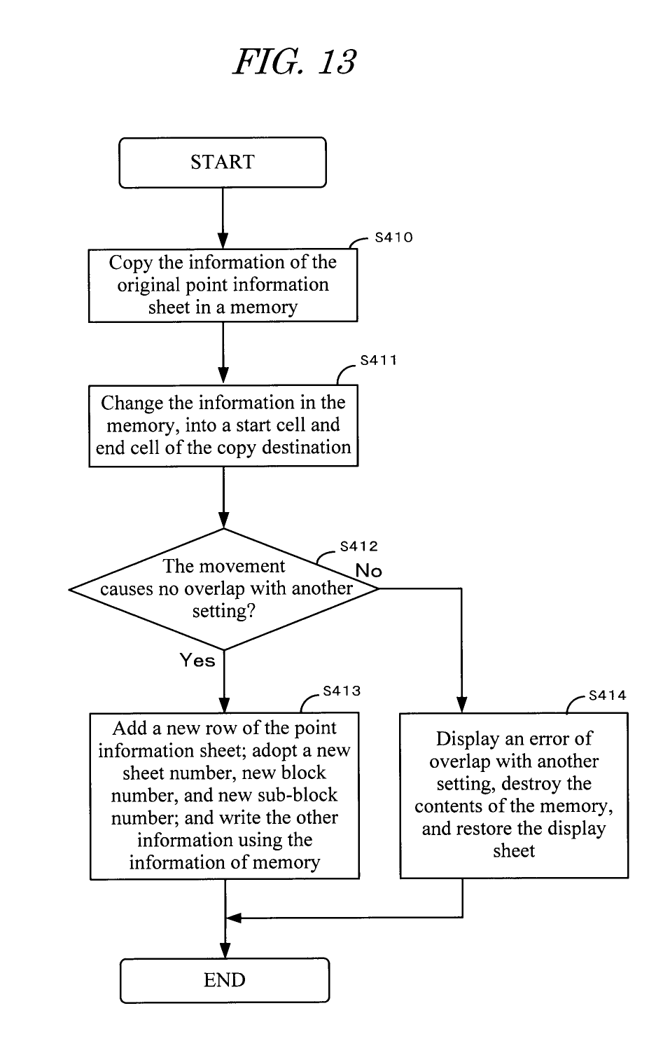

As shown in the flowchart of FIG. 13, the setting copy and paste part 038 copies the information of the original point information sheet 021 to be copied, in a specific memory (S410), and changes the information in the memory, into a start cell and end cell of the copy destination (S411).

Then, as a result of movement of the setting information, it is checked whether the setting overlaps another setting (S412), and when the setting does not overlap another setting (Yes in S412), a new row of the point information sheet 021 is added, and a new sheet number, a new block number, and a new sub-block number are adopted. The other information is written using the information stored in the memory (S413). On the other hand, when the setting overlaps another setting (No in S412), an error of overlap with the other setting is displayed, the contents stored in the memory is destroyed to restore the display sheet 020 to be an original state (S414).

With the fourth embodiment, the information of the specified range of the display sheet 020 of the objective business form 015 is temporarily stored in a memory, and when the paste destination is decided by the setting copy and paste part 038, a row is added to the point information sheet 021 of the objective business form 015, and a new block number and a new sub-block number are adopted. Then, the sheet number, start cell and end cell are saved, and the other information is input from the information temporarily stored in the memory, and copied together with the information of the display sheet 020.

### {Action and Effect}

In general, when editing the display sheet 020 by a copy function or cut function that are prepared by the table computation software 014, the information, which is set in advance in the point information sheet 021 different from the display sheet 020, can not be copied or cut. Therefore, even the information is apparently copied, there is a possibility that the data is only displayed in the original display position of the display sheet 020 on the basis of the information of the point information sheet 021, and the data is not displayed in the copy destination.

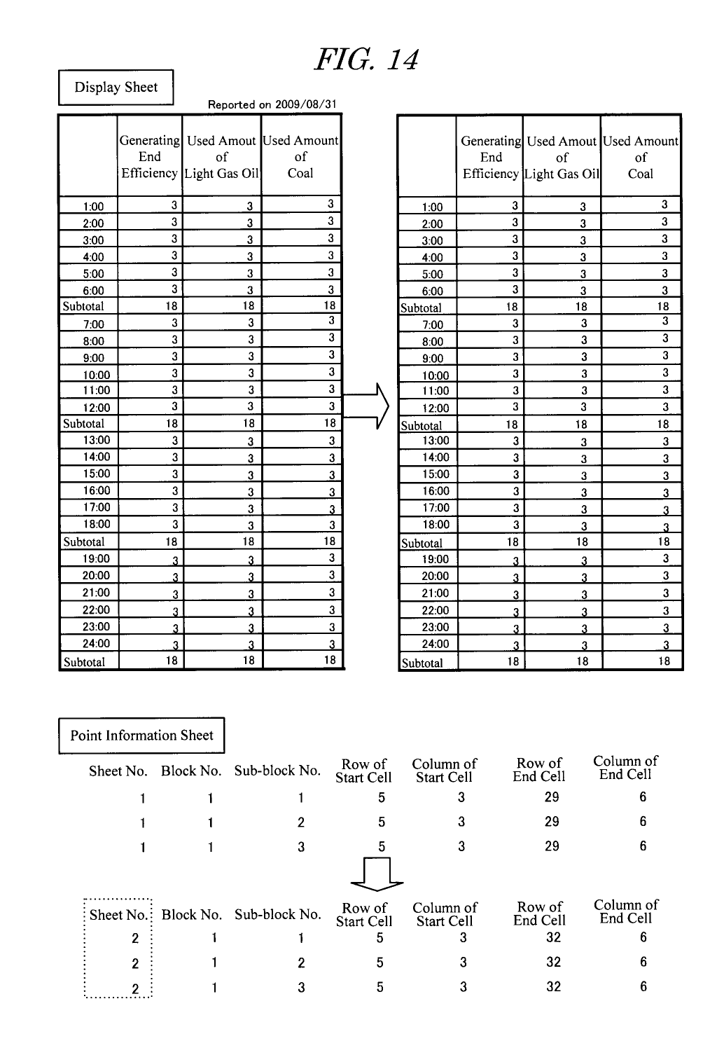

Thus, in the fourth embodiment, the setting copy and paste part 038 is defined in the built-in business form 016, and the setting copy and paste part 038 operates on the table computation software program 014, as a result, it is possible to copy, cut or paste the setting information to the point information sheet 021. This is a unique action and effect in the fourth embodiment. Specifically, as shown in FIG. 14, when a part of the generated business form is diverted to a new business form to be generated in another sheet, it is possible to specify a required matrix block in the original business form to be diverted, and copy the block and paste it to the other sheet.

As mentioned above, the fourth embodiment, which can copy not only the business form format but also the setting information, there is no defect in which the data is only displayed in the original display position of the display sheet 020 on the basis of the information of the point information sheet 021, and the data is not displayed in the copy destination. Therefore, a new business form can be generated and displayed efficiently. In other words, so as to keep consistency with the editing result of the objective business form 015, the consistency adjustment part automatically changes the additional position of plant data. Therefore, it is unnecessary for a user to change the point information sheet 021 and the business form definition program depending on the editing of the objective business form 015, the editing of the objective business form can be made readily.

### Fifth Embodiment

### {Configuration}

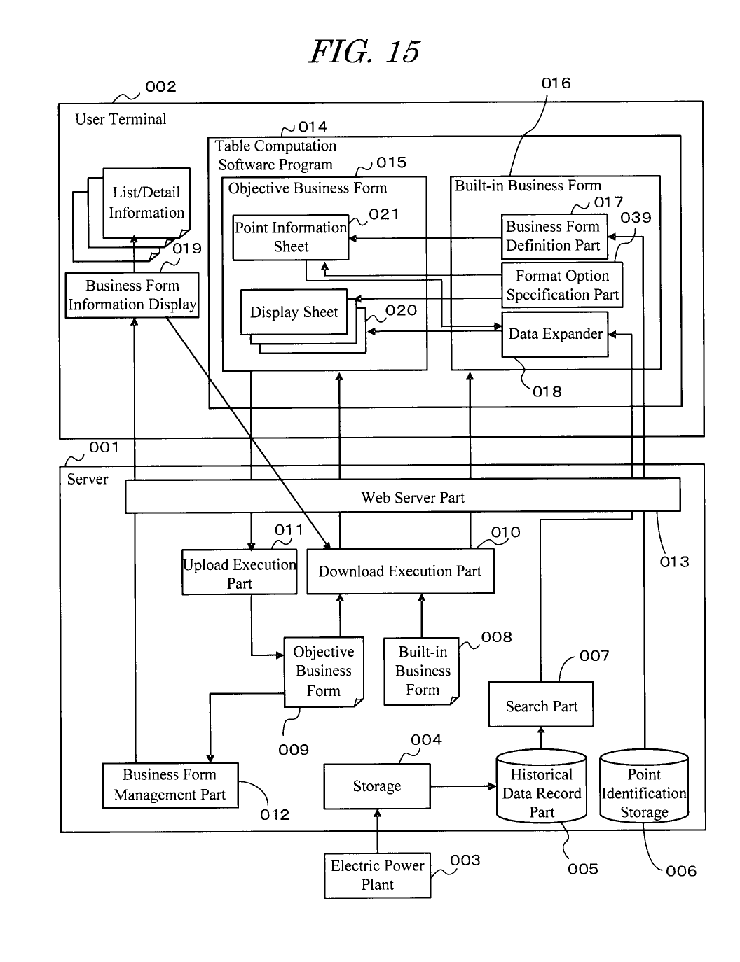

FIG. 15 shows a block diagram of a fifth embodiment. As shown in FIG. 15, in the fifth embodiment, as a program that operates on the table computation software program 014, the format option specification part 039 is defined in the built-in business form 016.

The format option specification part 039 is a program which specifies, for the point information sheet 021 of the objective business form 015, whether the option information, which includes at least point ID, name, unit of quantity, date and time, maximum value, minimum value, and mean value, is automatically added to the business form format. Note that the other configuration is the same as the second embodiment.

### {Display Example of Search Condition Specification Screen}

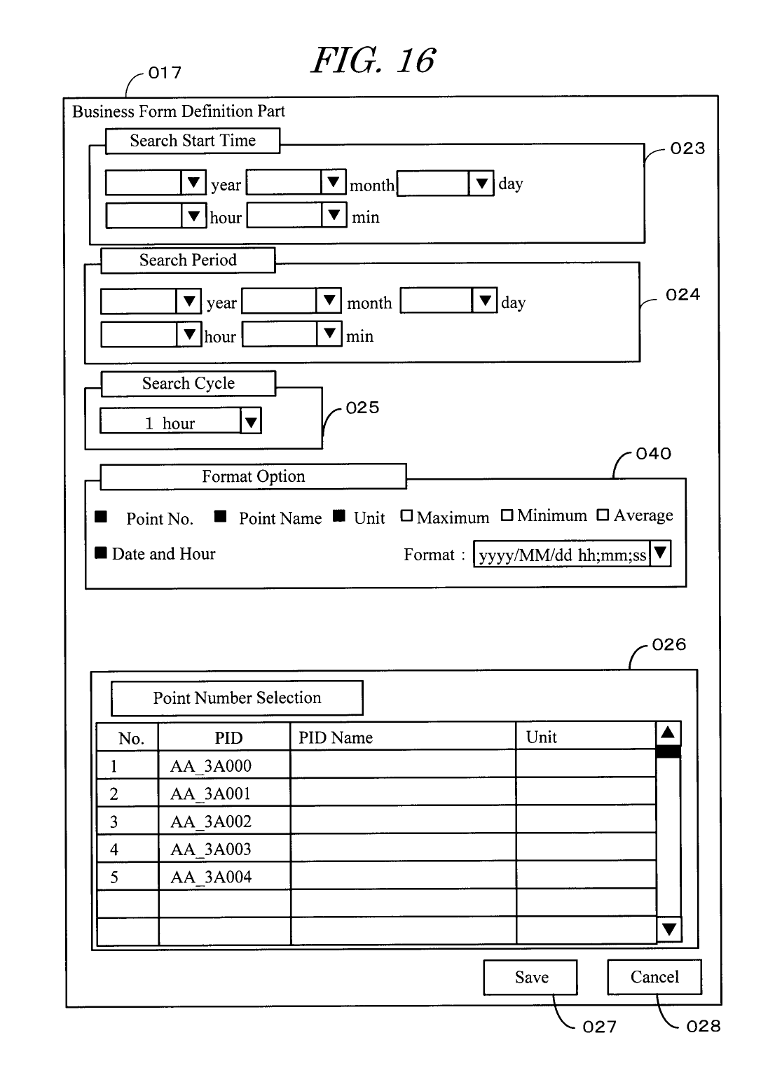

FIG. 16 shows an example of the business form definition part 017, to which a format option specification part is added. FIG. 16 shows the search condition selection screen of FIG. 3, which was explained about the second embodiment. A format option specification area 040 has been added to the screen by a format option specification part 039. Note that the specification of the check box displayed on the screen, is operated by a pointing device such as mouse.

As shown in FIG. 16, in the format option specification area 040, as an option information to be added to a business form format of the display sheet 020, point number, point name, unit of quantity, date and time of the historical data, maximum value, minimum value, mean value, and so on, are specified by a check box, and the specified conditions are stored in the memory.

When specifying the date and time, a format of the date and time can be selected by a pull-down menu. The additional information, which is not shown in FIG. 16, can include the displayed number of decimal places of the point number, the total of the historical data for a specified period. In addition, values embedded in the point information sheet 021, is used in a program, when expanding a business form format in the display sheet 020, the format options are expanded in the order specified in the program.

When the point number, point name, unit of quantity, are selected as option, the data expander 018 embeds the identification information of the point number from the point identification information, to the display sheet 020. In addition, when the date and time of the historical data is selected as option, the date and time of the historical data is expanded on the display sheet 020, on the basis of the information of search start date and time, search period, search cycle. Further, when the option of maximum value, minimum value, mean value, are selected, a value is computed from the historical data to be expanded on the display sheet 020, and the values are expanded on the display sheet 020.

### {Display Example of Point Information Sheet}

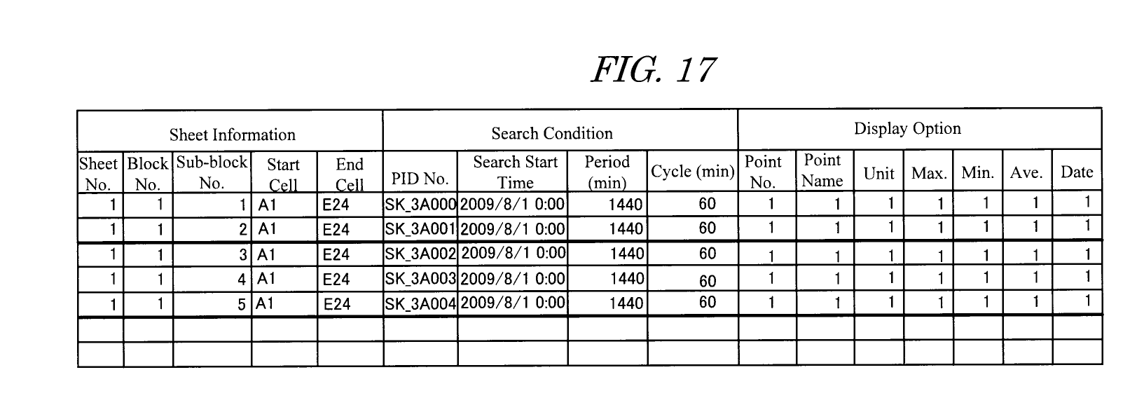

FIG. 17 shows an example of the point information sheet 021 for which the search conditions are specified by the business form definition part 017 shown in FIG. 16. FIG. 17 shows the point information sheet 021 of FIG. 5, to which columns are added for the format option. The stored values can be such as to judge as to whether the option is selected, in FIG. 17, when the option is selected, value “1” is stored.

### {Display Example of Display Sheet 020}

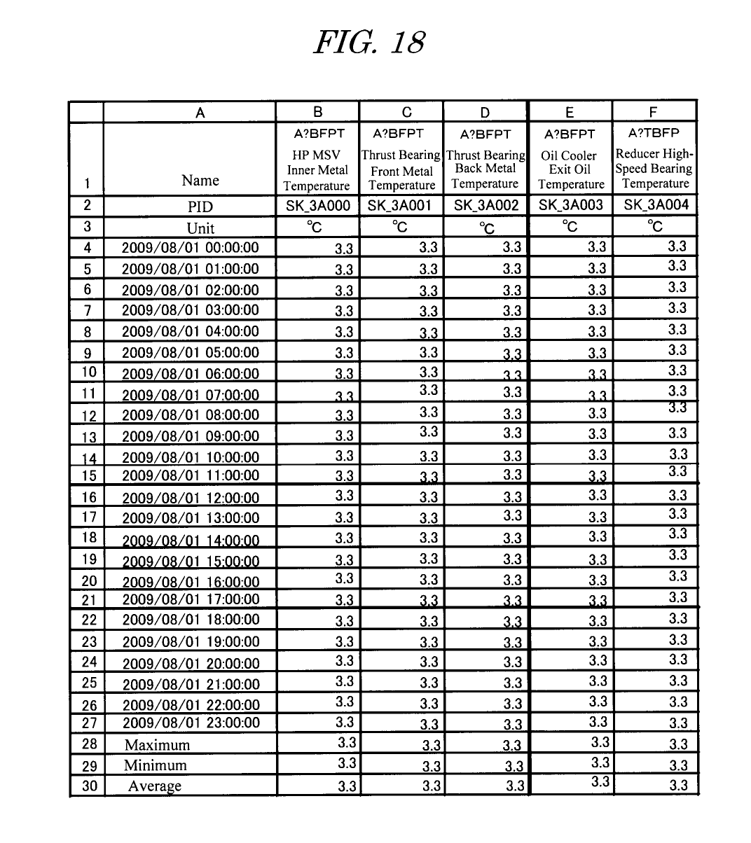

FIG. 18 shows a business form which is expanded on the display sheet 020, on the basis of the information stored in the point information sheet 021 shown in FIG. 17. Here, the business form format is programmed such that a point name, point number, unit of quantity, the historical data of the specified period, maximum value, minimum value, mean value, are expanded in this order. If the option of minimum value is not selected, the mean value is expanded on not the 30th row, but the 29th row.

### {Action and Effect}

With the fifth embodiment mentioned above, in addition to the action and effect of the first embodiment, the following unique action and effect can be obtained. That is, the selection state of items to be added to the business form format, can be stored in the point information sheet 021, and the stored values allows the information of selected option to be expanded on the business form format.

Consequently, the time required for generating a business form, can be made substantially shorter. In addition, the information of option selection can be managed by the point information sheet 021, if only modifying the stored data, a business form format can be readily modified any number of times.

Further, a work of manually setting in advance the information of the point number to be set in a business form format at a design stage, allowing it in a non-display state, and selecting the format option at a test stage. The contents of the format to be expanded can be compared with the contents in the non-display, to review the comparison result, a check test or specification of problem can be made readily.

### Sixth Embodiment

### {Configuration}

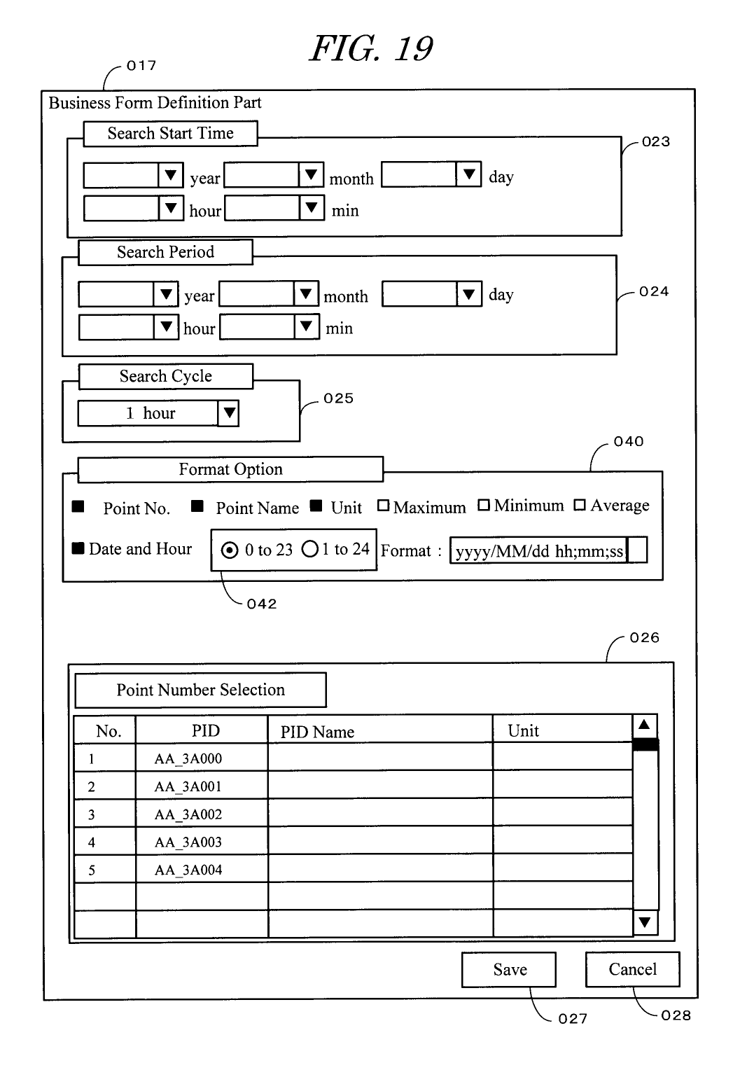

Next, a sixth embodiment is explained referring to the block diagram of FIG. 19. The sixth embodiment has a feature of the configuration in which a date and time format specification part 041 is defined in the built-in business form 016, as a program that operates on the table computation software program 014.

The date and time format specification part 041 is a program which specifies as display format of the date and time that is added to the data as a search result, either of a display type of 0:00 to 23:00, or a display type of 1:00 to 24:00. The other configuration is the same as the second embodiment.

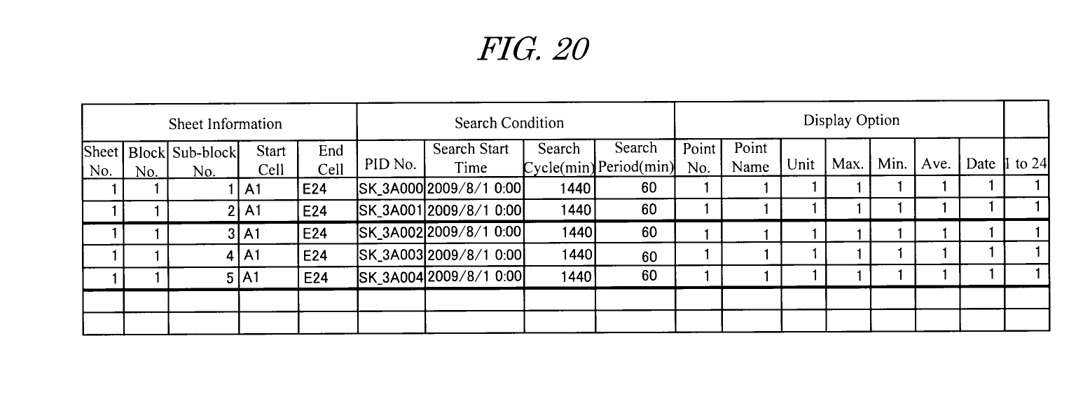

FIG. 20 shows a display example of a drawing in which a date and time format specification area 041 is added to the format option specification area 042 of the search condition selection screen shown in FIG. 16. In the date and time format specification area 042, either of the types of 0:00 to 23:00 or 1:00 to 24:00, can be selected by a pointing device such as mouse.

The selected information is stored in a memory, and embedded in the point information sheet. For example the type of 1:00 to 24:00 is selected, as an operation journal data for one day, the data of 1:00 to the next day 0:00 is searched in the computer. In addition, when an option of display the date and time of the historical data is selected in the format option, the date and time of the business form format is displayed as 1:00 to 24:00.

### {Display Example of Point Information Sheet 021}

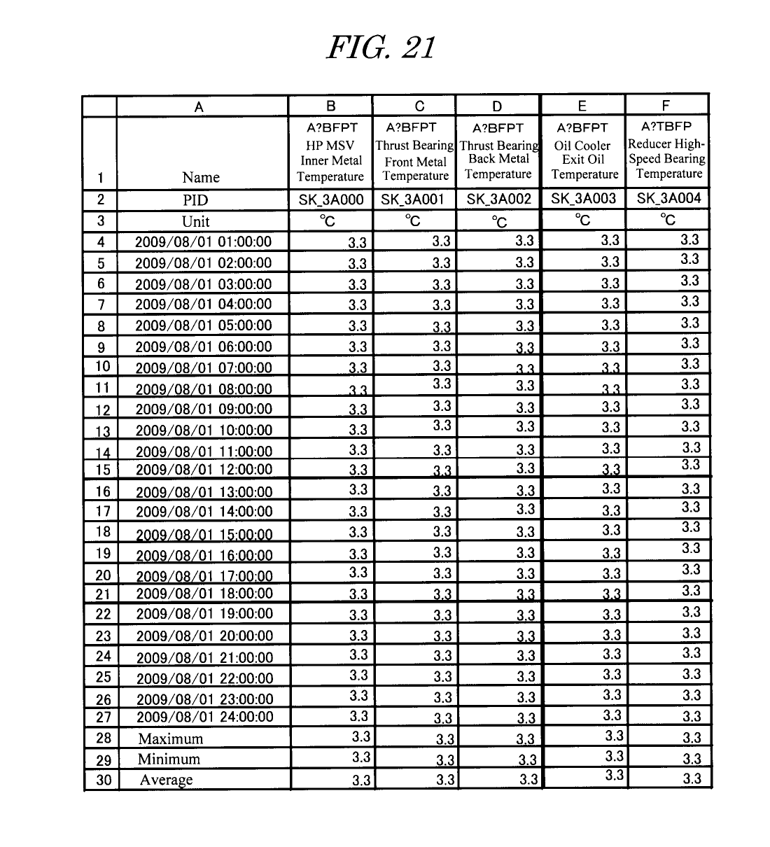

FIG. 21 shows an example of the point information sheet in which the search conditions are specified by the business form definition part 017 shown in FIG. 20. FIG. 21 shows the point information sheet 021 of FIG. 17, to which a column for the date and time is added. The stored values can be such as to judge as to which is selected from the types of 0:00 to 23:00 and 1:00 to 24:00. In FIG. 21, when the type of 1:00 to 24:00 is selected, value “1” is stored.

### {Display Example of Display Sheet}

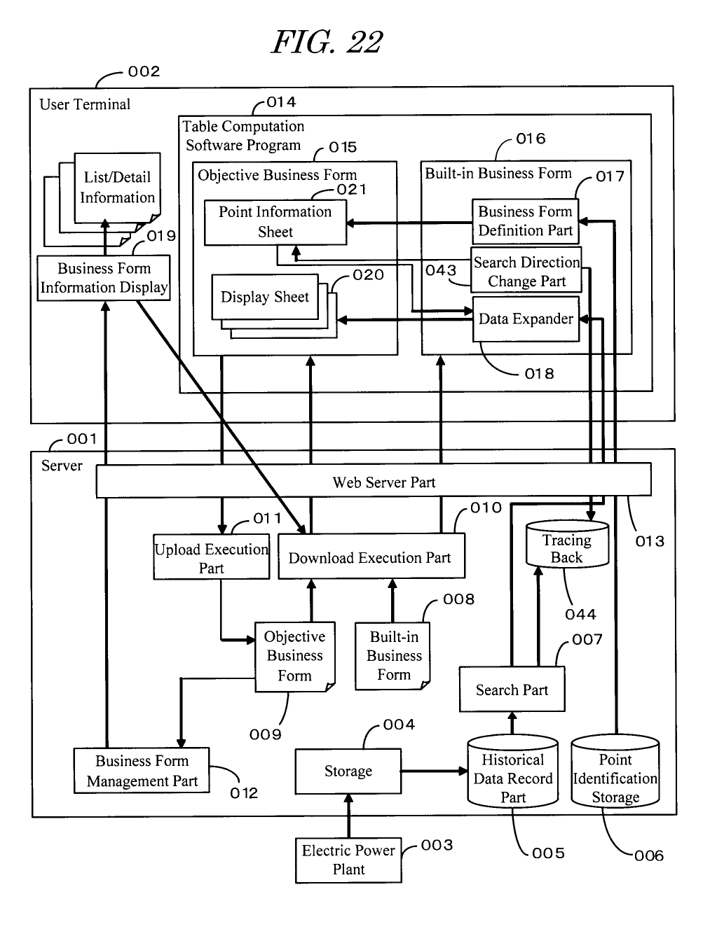

FIG. 22 shows a business form format that is expanded on the display sheet, on the basis of the information stored in the point information sheet 021 of FIG. 21.

### {Action and Effect}

The historical data includes an operation journal regular time data, which is generated by aggregating for each one hour. The operation journal regular time data is generated, for example, by aggregating process values in a cycle of one minute, during 0:00 to 0:59, and recording the aggregated data as a data of 1:00. Here, the operation journal regular time data, which is generated by aggregating the values of 23:00 to 23:59, is handled as a data of 24:00.

Note that in the time processing of computers, the time stamp of 24:00 cannot be handled, so inside the computer, the data is stored with the time stamp of the next day 0:00. When the operation journal regular time data is searched for one day and displayed, it can be required to search the data of 1:00 to the next day 0:00, and display as 1:00 to 24:00 in terms of display of business form.

Thus, the sixth embodiment, by specifying the date and time format by the date and time format specification part 041, this method can be flexibly adapted to either of the types of 0:00 to 23:00 and 1:00 to 24:00. In addition, when generating a journal regarding the whole electric power plant, even if different aggregation methods are used for individual monitoring and control computers, if only the date and time format is specified by the date and time format specification part 041, the method can be readily adapted to the aggregation method of the monitoring and control computers.

### Seventh Embodiment

### {Configuration}

FIG. 22 shows a block diagram of a seventh embodiment. The seventh embodiment has a technical feature in which a search direction change part 043 is defined is defined in the built-in business form 016, as a program that operates on the table computation software program 014.

The search direction change part 043 is a program that selects either of specifying the date and time span of period or the number of periods from the search start point in a forward direction (future direction), or specifying the date and time span of period or the number of periods from the search start point in a reverse direction (past direction). Further, in the server 001, tracing back information storage 044 is provided, which generates in advance tracing back information in the past direction and stores it. Note that the other configuration is the same as the second embodiment.

### {Display Example of Search Condition Specification Screen}

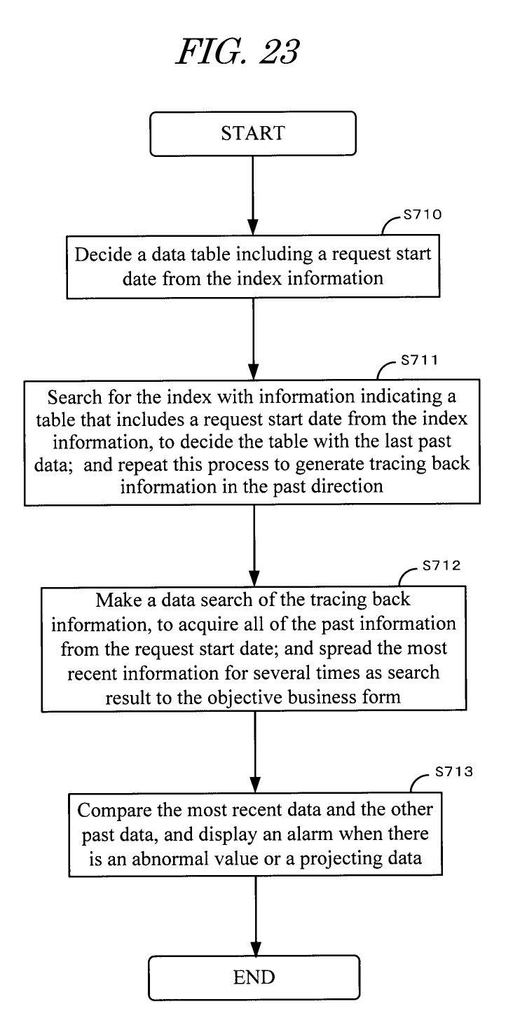

FIG. 23 shows a display example of the search condition specification screen displayed by the business form definition part 017. The selection and execution of each area or button displayed on the screen are operated by a pointing device such as mouse. On the search condition specification screen shown in FIG. 23, in addition to the screen shown in FIG. 20, a search pattern 045 and the number of display items 046 are displayed.

### {Process Flow}

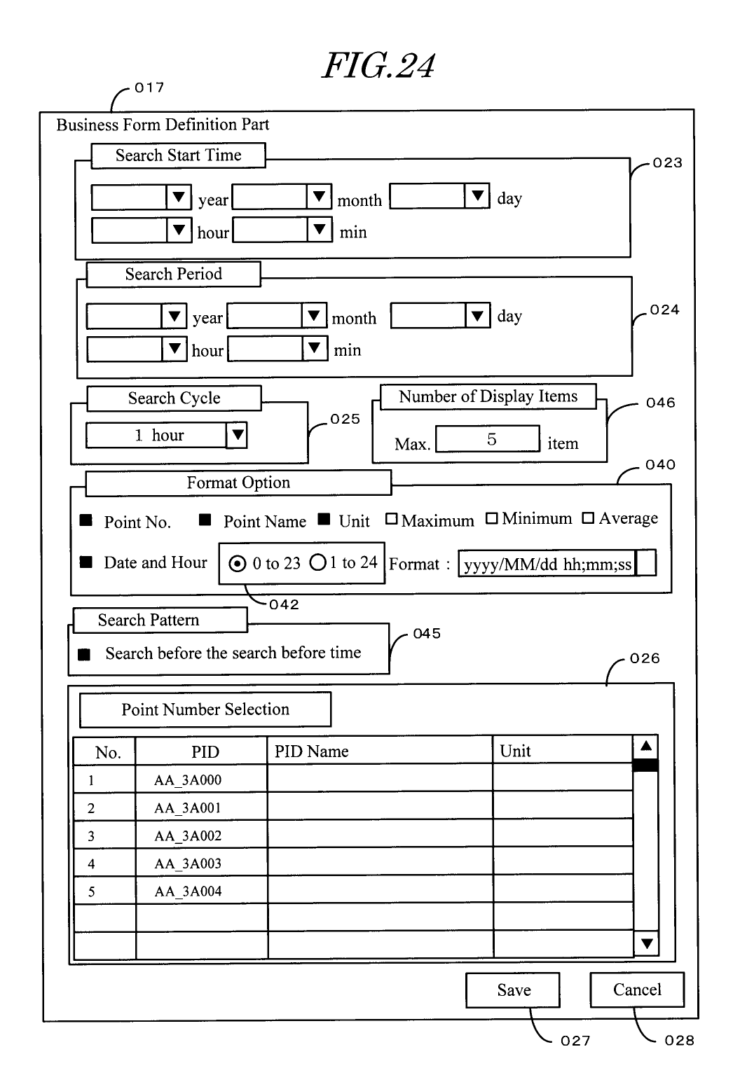

The flowchart of FIG. 24 shows an example of a process flow when changing the search direction. In other words, when a data table including a request start date is decided from the index information (S710), a search is made for the index with information indicating a table that includes a request start date from the index information, to decide the table with the last past data. This process is repeated to generate tracing back information in the past direction (S711).

Subsequently, a data search of the tracing back information is made, all of the past information from the request start date is acquired, and the most recent information for several times is expanded as search result to the objective business form (S712). Further, the most recent data and the other past data are compared with each other, and when there is an abnormal value or a projecting data, an alarm is displayed (S713).

### {Action and Effect}

With the seventh embodiment, the search direction change part 043 selects the reverse direction (the past direction) from the search start point, the search pattern 045 is specified so as to be directed to the past, the following action is made.

In other words, by tracing back the data using the time information added to the data from the reference time point in the past direction, for the specified number of display items 046 (five matters in FIG. 23), the data is searched from the reference time point in the past direction, to be displayed. In addition, the data can be sorted from the oldest data in the direction of the reference time point and displayed. The data is searched from the search start point in the past direction, an investigation of the cause of events such as abnormality can be made efficiently.

In addition, the seventh embodiment, if only specifying the number of display items 046, the desired number of data can be sampled from the search start point. Therefore, one data group can be compared when the same event or similar event occurred in the past, or on the basis of the same conditions or similar conditions in the past. Further, a projecting value or abnormal value can be found out, and a comparison of the secular change can be made. Consequently, this method is favorable for the investigation of the cause of events.

Further, when the search direction change part 043 selects the forward direction (future direction), and the search pattern 042 is specified so as to be directed to the future, the following action is made. That is, by tracing the information for acquiring the data from the past in the future direction, to which a time information is added in advance, a reverse lookup information is generated, which is information for acquiring the data by tracing back the data from the future in the past direction. The search part 007 can perform a data search on the basis of the reverse lookup information.

Consequently, a data search from the future to the past can be at a high speed. Therefore, an high accuracy investigation can be made, regarding how the influence of an event such as an abnormality generated in the electric power plant, has expanded to in the time axis from a point of time in the past to the future.

### Eighth Embodiment

### {Display Example of Configuration and Search Condition Specification Screen}

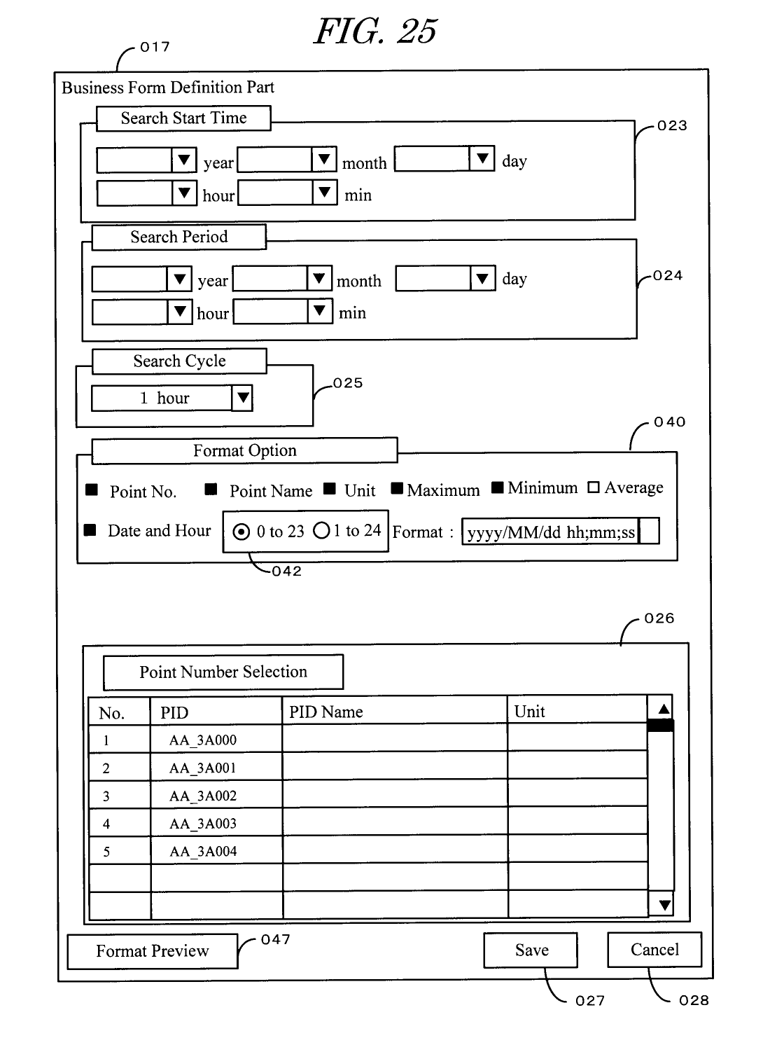

Next, an eighth embodiment is explained. FIG. 25 shows a display example of a search condition specification screen displayed by the business form definition part 017.

In the eighth embodiment, as a program operated on the table computation software program 014, a preview display part 044 is defined in the built-in business form 016, and displayed on the search condition specification screen. The preview display part 044 previews a display image to be checked prior to reflect the settings in the objective business form.

### {Display Example of Preview Screen}

When selecting the preview display part 044 by a mouse, and starting a program for displaying a preview, an image of a business form format is displayed on the selected search condition and stored in a memory. The business form format can be visually checked by the preview without modifying the existing search conditions set in advance.

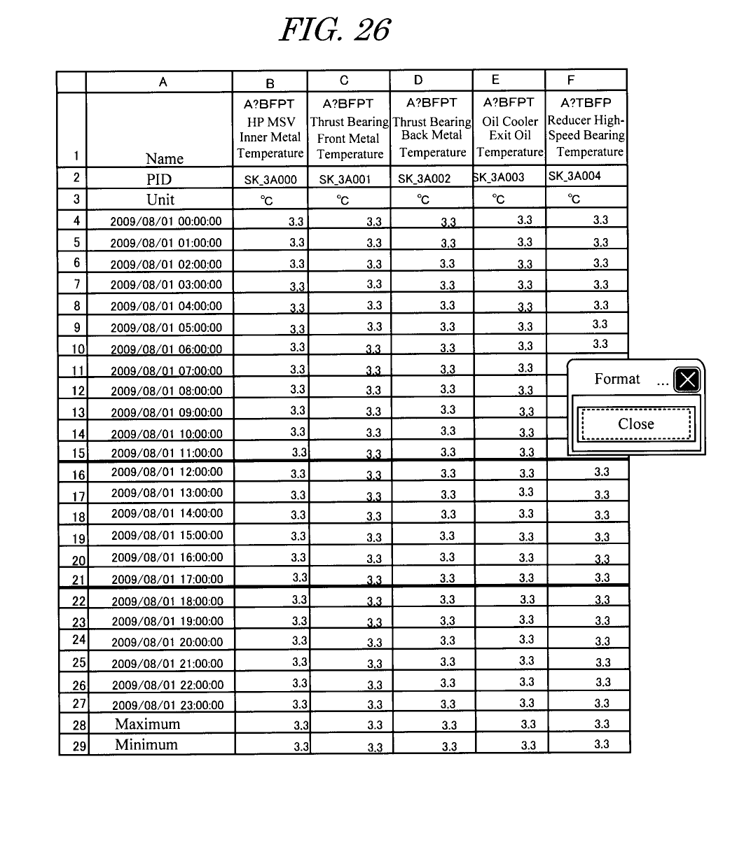

FIG. 26 shows an example of preview screen. FIG. 26 is a preview screen that is displayed on the search conditions selected in FIG. 25. In the preview display, not a real data, but a sample numerical value is employed for values embedded in the historical data part.

FIG. 26, a sample numerical value “3.3” is used. The use of a numeric character having a large character width such as “3” or “8”, or a decimal point, prevents a lack of a real numerical value when a historical data is embedded in a business form format. When close a preview, a close button displayed in a popup window is selected by a mouse or the like.

### {Action and Effect}

With the eighth embodiment, an action and effect can be obtained, in which an image of a business form format, which is displayed on the conditions selected by the business form definition part 017, can be visually checked. Here, by temporarily storing a preview screen in another location different from the location such as a memory, in which existing setting conditions are stored, it is unnecessary to modify the existing setting conditions. Further, even if during a work of defining a business form, an image of the business form can be visually checked. Therefore, work efficiency can be enhanced.

### Ninth Embodiment

### {Configuration}

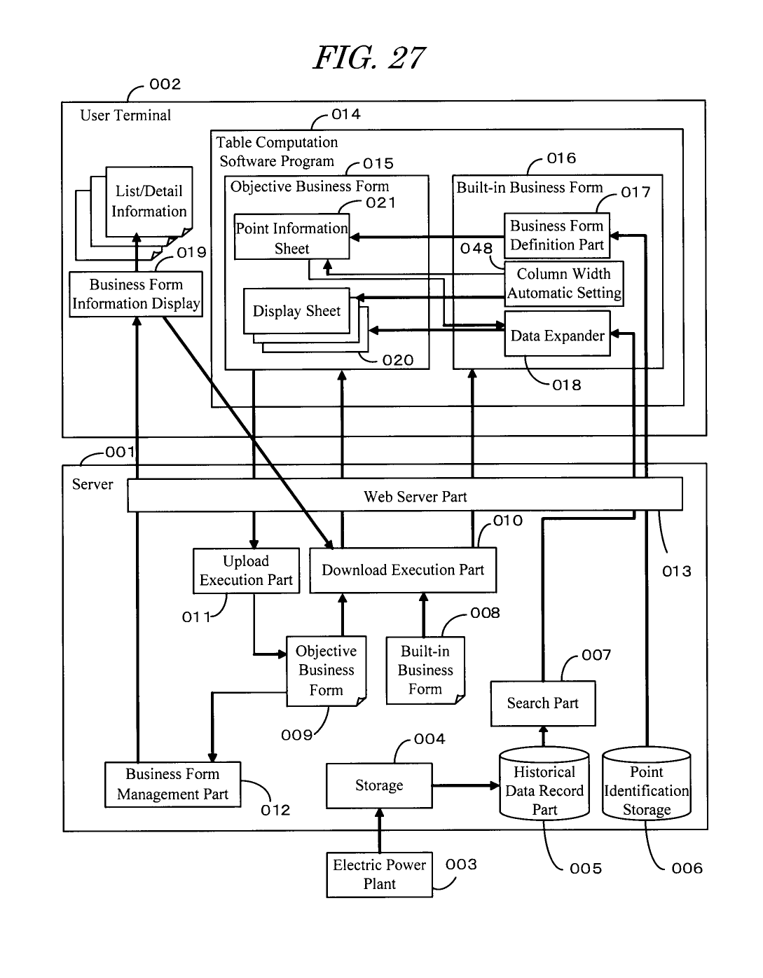

FIG. 27 is a block diagram of a ninth embodiment. In the ninth embodiment, a column width automatic setting part 048 operates in the built-in business form 016 on the table computation software program 014.

The column width automatic setting part 048 is configured as follows. That is, the column width automatic setting part 048 automatically adjusts a column width or a font size in proportion to the maximum number of significant figures which is different for each sensor when automatically generating a format. In addition, the column width automatic setting part 048 may automatically adjust a column width or a font size in proportion to the maximum number of significant figures of data in each column after sensor values have been acquired actually.

### {Process Flow}

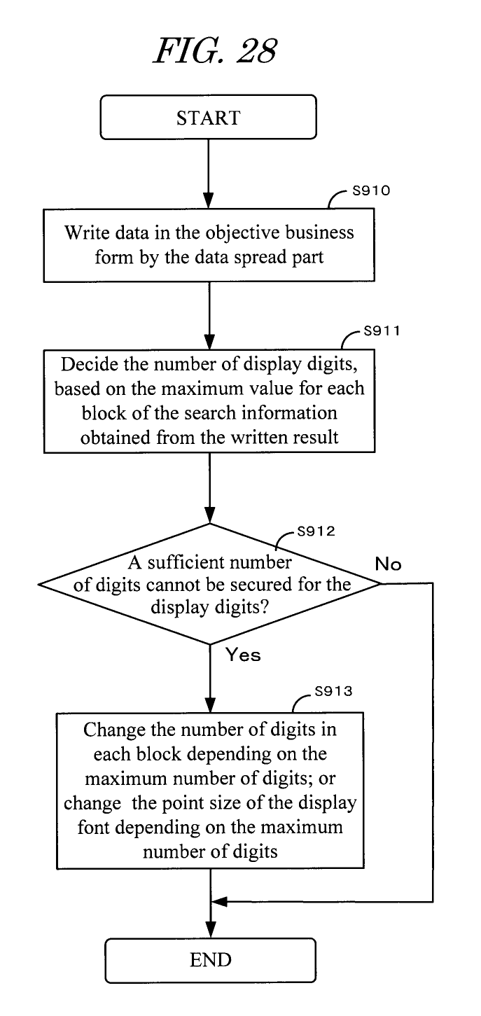

FIG. 28 shows a process flow of the column width automatic setting. First, when the data expander 018 has written data in the objective business form 015 (S910), since the maximum value for each block of the search information is obtained from the written result, and the number of display digits is decided (S911).

Next, in a step S912, it is checked as to whether a sufficient number of digits can be secured for the display digits. If it can be secured (No in S912), the process ends as it is. On the other hand, if it cannot be secured (Yes in S912), the column width automatic setting part 048 changes the number of digits in each block depending on the maximum number of digits. In addition, when the number of digits in each block can not be changed, the column width automatic setting part 048 changes the point size of the display font such that the maximum number of digits can be displayed.

### {Action and Effect}

With the ninth embodiment, when setting the point identification information such as point number, point name, unit of quantity, into the point information sheet 021 of the objective business form 015, the column width automatic setting part 048 can automatically set a column width or a font in the display sheet 020, depending on the number of significant figures of the point identification information.

In addition, by action of the column width automatic setting part 048, when actually displaying the search data by the data search part 007, the column width or font can be automatically set again depending on the maximum number of significant figures of each data. Consequently, an overflow or needless blank space can be prevented from occurring when a data is displayed on the display sheet 020. This can provide a display sheet excellent in visual recognition.

### Tenth Embodiment

### {Display Example of Configuration and Search Condition Specification Screen}

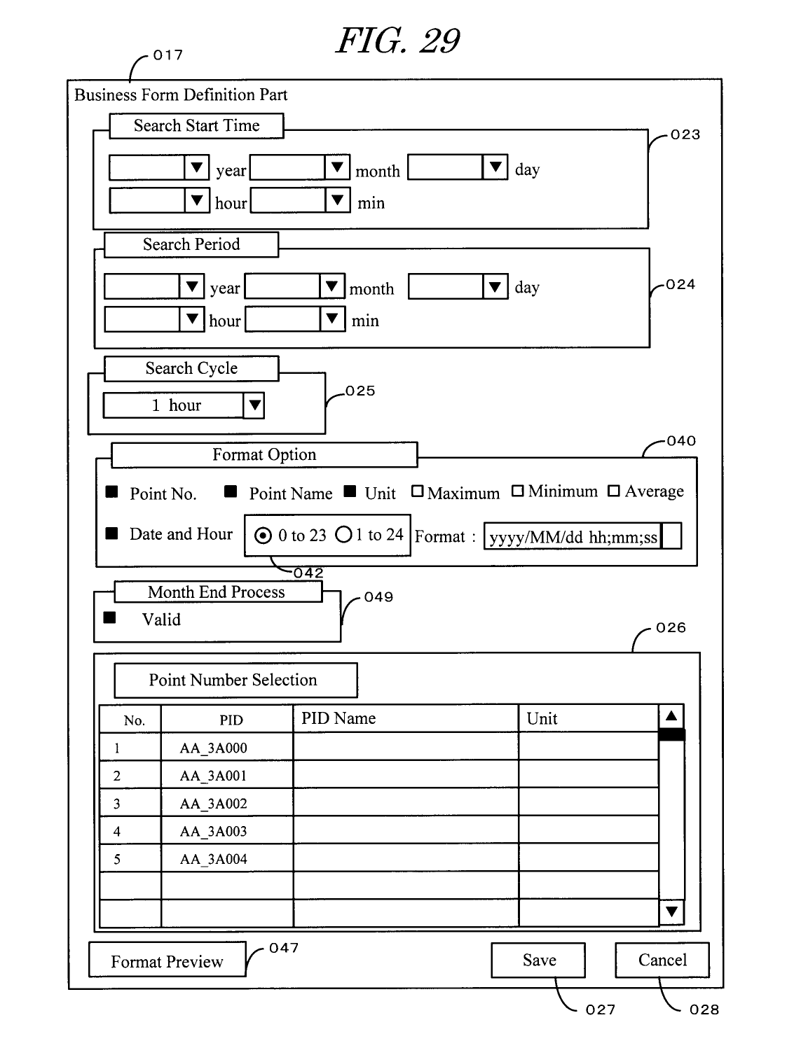

A tenth embodiment is explained. FIG. 29 shows a display example of a search condition specification screen displayed by the business form definition part 017. FIG. 29 shows a screen in which a month end processing part 049 is added to the search condition specification screen of the eighth embodiment, and the screen is adapted to select as to whether a month end process is to be effective by operating a mouse or the like.

The month end processing part 049 is defined in the built-in business form 016, as a program that operates on the table computation software program 014. The month end processing part 049 is adapted to automatically adjust the display contents of the objective business form 015, depending on the number of days of a month, which is different for each month.

In more detail, when the information selected by the month end processing part 049 is stored in a memory, a value of the information is embedded in a column for the month end process within the point information sheet 021, the embedded value is used when expanding a business form format. In other word, when the month end process is allowed to be valid for a business form generated for each month such as a monthly report, in a month with 30 days, cells of the row corresponding to the 31st day are blank, and in February, cells of the rows corresponding to the 29th day to the 31st day are blank. Note that in a leap year, in February, cells of the rows corresponding to 30th day to 31st day are blank.

### {Display Example of Point Information Sheet 021}

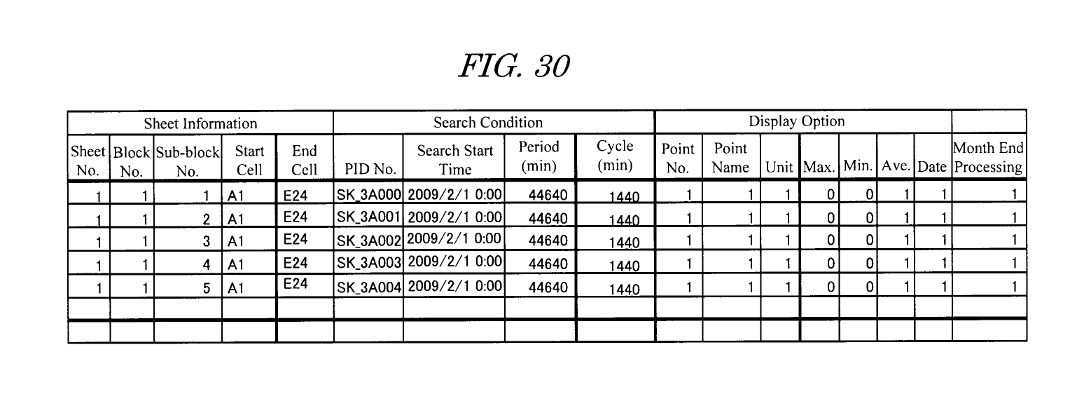

FIG. 30 shows an example of the point information sheet 021 in which the search conditions are specified by the business form definition part 017 shown in FIG. 29. FIG. 30 shows search conditions for expanding a monthly report of February, in which the search start date and time is “the 1st day of February, 2009, time: 00:00”, to a business form format. The point information sheet 021 is adapted such that a judgment can be made as to whether the month end process is to be effective. In FIG. 30, when the month end process is allowed to be effective, the value “1” is stored in the columns for the month end process.

### {Display Example of Display Sheet 020}

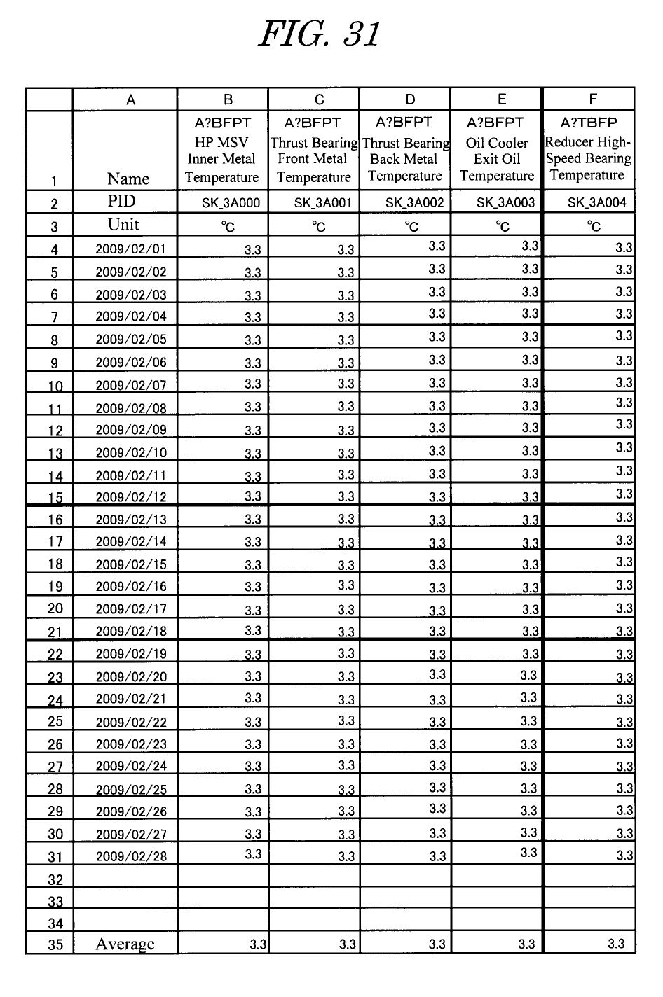

FIG. 31 shows a business form format which is expanded to a display sheet 020, on the basis of the information stored in the point information sheet 021 of FIG. 30. Since the month end process in February is allowed to be effective, cells of the rows corresponding to the 29th day to 31st day are blank.

### {Action and Effect}

With the tenth embodiment as described above, in addition to the actions and effects of the first embodiment, the following action and effect can be achieved. In other words, when generating a business form for each month such as a monthly report, the month end processing part 049 is selected to make the month end process effective, the one pattern format can be applied to business forms of all months. Consequently, it is unnecessary to use four pattern formats depending on the number of days in a month, that is, 28 days, 29 days, 30 days, and 31 days, and business forms can be generated and displayed efficiently.

### Other Embodiment

In the above-mentioned embodiments, the configuration of each part can be appropriately changed, and a combination of two or more embodiments also can be made. In addition, in the above-mentioned embodiments, a technique of controlling a computer with peripheral devices by a program was explained, but as another embodiment, a storage medium, in which a program is stored and causes a computer to execute each process, also can be provided. Further, the above-mentioned embodiments are applied to a system for generating and displaying a plant data business form of an electric power plant, but the techniques explained about the embodiments also can be applied to the other types of plants.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A plant data business form management system which is incorporated in a server and a user terminal that are adapted to be connected with each other via a communication network, and generates and displays a business form in response to a request form a user, based on plant data which indicates an operation state of a plant,
wherein the server comprises:
a first storage which is configured to store an objective business form that has a business form format displaying plant data;
a second storage which is configured to store a business form generation program that is provided separately from the objective business form;
a built-in business form modification part which modifies the business form generation program;
a download execution part which transmits the objective business form and the business form generation program stored in the first and second storage to the user terminal; and
a search part which searches for the plant data in response to a request from the user terminal and transmits the obtained plant data to the user terminal,
wherein the business form generation program includes:
a business form definition program which sets search conditions of plant data in the objective business form; and
a data expansion program which requests the server to search for the plant data that satisfies the search conditions in the objective business form and outputs the plant data to the objective business form,
wherein the user terminal comprises:
an objective business form editing part which edits the objective business form that has been transmitted by the download execution part; and
a business form generation part which executes the business form generation program to output the plant data to the edited objective business form.

2. The plant data business form management system according to claim 1,
wherein the server further comprises:
an upload execution part which allows the objective business form edited by the objective business form editing part to be uploaded to the server, and saves it in the first storage.

3. The plant data business form management system according to claim 2,
wherein the user terminal further comprises:
a list query part which specifies conditions and requests the server to generate a list;
a display part which displays the list transmitted from the server; and
a download request execution part which requests the download execution part to download the objective business form selected from the list, and
wherein the server further comprises:
an objective business form management part which generates a list of the objective business form stored in the first storage, and transmits the list to the user terminal.

4. The plant data business form management system according to claim 1,
wherein the objective business form includes:
a display sheet which allows search conditions of the plant data to be embedded therein, and is displayed on a screen; and
a point information sheet in which the search conditions of the plant data to be embedded in the display sheet are stored.

5. The plant data business form management system according to claim 4,
wherein the point information sheet includes information that indicates a position within the objective business form in which the plant data is embedded,
wherein the business form generation part further comprises a consistency adjustment program, and
wherein the objective business form generation part comprises:
a consistency adjustment part which executes the consistency adjustment program, and changes the information that indicates a position within the objective business form, depending on an editing result of the objective business form edited by the objective business form editing part.

6. The plant data business form management system according to claim 5,
wherein the consistency adjustment part includes a matrix insertion and deletion part, and
wherein the matrix insertion and deletion part allows insertion and deletion of a row or column to be reflected in the point information sheet of the objective business form, between a plurality of points or between a plurality of date and times that defines a period of time.

7. The plant data business form management system according to claim 5,
wherein the consistency adjustment part includes a setting copy and paste part, and
wherein the setting copy and paste part allows copy or cut of setting information that includes a plurality of points and a period of time, and paste of the copied or cut setting information to any different area, to be reflected in the point information sheet of the objective business form.

8. The plant data business form management system according to any of claims 1 to 3,
wherein the business form generation program includes a format option specification program, and
wherein the user terminal further comprises:
a format option specification part which executes the format option specification program, and displays a screen that is adapted to specify, for the point information sheet of the objective business form, whether option information, which includes at least point ID, name, unit of quantity, date and time, maximum value, minimum value, and mean value, is automatically added to the business form format.

9. The plant data business form management system according to any of claims 1 to 3,
wherein the business form generation program includes a date and time format specification program, and
wherein the user terminal further comprises:
a date and time format specification part which executes the date and time format specification program, and displays a screen that is adapted to specify as display format of the date and time that is added to the data as a search result, either of a display type of 0:00 to 23:00, or a display type of 1:00 to 24:00.

10. The plant data business form management system according to any of claims 1 to 3,
wherein the business form generation program includes a search direction change program, and
wherein the user terminal further comprises:
a search direction change part which executes the search direction change program, and displays a screen that is adapted to select either of specifying the date and time span of period or the number of periods from a search start point in a forward direction (future direction), or specifying the date and time span of period or the number of periods from the search start point in a reverse direction (past direction).

11. The plant data business form management system according to any of claims 1 to 3,
wherein the business form generation program includes a preview display program, and
wherein the user terminal further comprises:
a preview display part which executes the preview display program, and displays a preview of a display image of the objective business form.

12. The plant data business form management system according to any of claims 1 to 3,
wherein the business form generation program includes a column width automatic setting program, and
wherein the user terminal further comprises:
a column width automatic setting part which executes the column width automatic setting program, and performs one of:
automatically adjusting a column width or a font size in proportion to the maximum number of significant figures which is different for each sensor when automatically generating a format; and
automatically adjusting a column width or a font size in proportion to the maximum number of significant figures of data in each column after sensor values have been acquired actually.

13. The plant data business form management system according to any of claims 1 to 3,
wherein the business form generation program includes a month end processing program, and
wherein the user terminal further comprises:
a month end processing part which executes the month end processing program, and automatically adjusts the display contents of the objective business form, depending on the number of days of a month, which is different for each month.

14. A plant data business form management method which by a server and a user terminal that are adapted to be connected with each other via a communication network, generates and displays a business form in response to a request form a user, based on plant data which indicates an operation state of a plant,
wherein the server comprises:
a first storage which is configured to store an objective business form that has a business form format displaying plant data; and
a second storage which is configured to store a business form generation program that is provided separately from the objective business form,
wherein the business form generation program includes:
a business form definition program which sets search conditions of plant data in the objective business form; and
a data expansion program which requests the server to search for the plant data that satisfies the search conditions in the objective business form and outputs the plant data to the objective business form,
wherein the server performs the steps of:
modifying the business form generation program;
transmitting the objective business form and the business form generation program stored in the first and second storage to the user terminal; and
searching for the plant data in response to a request from the user terminal and transmitting the obtained plant data to the user terminal,
wherein the user terminal performs:
editing the objective business form downloaded from the server; and
executing the business form generation program to output the plant data to the edited objective business form.

15. A plant data business form management program which causes a server and a user terminal that are adapted to be connected with each other via a communication network, to generate and display a business form in response to a request form a user, based on plant data which indicates an operation state of a plant,
wherein the plant data business form management program causes the server to function as:
a first storage which is configured to store an objective business form that has a business form format displaying plant data;
a second storage which is configured to store a business form generation program that is provided separately from the objective business form;
a built-in business form modification part which modifies the business form generation program;
a download execution part which transmits the objective business form and the business form generation program stored in the first and second storage to the user terminal; and
a search part which searches for the plant data in response to a request from the user terminal and transmits the obtained plant data to the user terminal,
wherein the business form generation program includes:
a business form definition program which sets search conditions of plant data in the objective business form; and
a data expansion program which requests the server to search for the plant data that satisfies the search conditions in the objective business form and outputs the plant data to the objective business form,
wherein the business form generation program causes the user terminal to function as:
an objective business form editing part which edits the objective business form that has been transmitted by the download execution part; and
a business form generation part which executes the business form generation program to output the plant data to the edited objective business form.
